(19) United States
(12) Patent Application Publication
(10) Pub. No.: US 2026/0292135 A1
(43) Pub. Date: Sep. 24, 2026

(54) VIDEO CODING METHOD AND APPARATUS FOR IMPROVING CHROMA PREDICTION BY FUSION

(71) Applicant: MEDIATEK INC., Hsin-Chu (TW)

(72) Inventors: Man-Shu Chiang, Hsinchu City (TW); Chia-Ming Tsai, Hsinchu City (TW); Yu-Ling Hsiao, Hsinchu City (TW); Chih-Wei Hsu, Hsinchu City (TW); Ching-Yeh Chen, Hsinchu City (TW); Tzu-Der Chuang, Hsinchu City (TW)

(73) Assignee: MEDIATEK INC., Hsin-Chu (TW)

(21) Appl. No.: 19/471,706

(22) PCT Filed: Apr. 24, 2024
(86) PCT No.: PCT/CN2024/089660

§ 371 Date: Oct. 2, 2025

Related U.S. Application Data
(60) Provisional application No. 63/497,757, filed on Apr. 24, 2023.
(60) Provisional application No. 63/498,855, filed on Apr. 28, 2023.

(51) Int. Cl. H04N 19/105; H04N 19/159; H04N 19/176; H04N 19/196

(52) U.S. Cl. CPC H04N 19/105; H04N 19/159; H04N 19/176; H04N 19/196

(57) ABSTRACT

A method for video coding includes: receiving data to be encoded or decoded as a current block of pixels of a current picture of a video, wherein the current block includes a luma block and at least one chroma block; and encoding or decoding the current block by a target prediction mode, including: obtaining a first data, wherein the first data is derived from cross-component prediction of chroma samples of the current block or luma reconstructed samples of the current block; obtaining a second data, wherein the second data is derived from intra chroma prediction of the chroma samples of the current block or inter chroma prediction of the chroma samples of the current block; and determining prediction of the chroma samples of the current block by jointly considering the first data and the second data.

### BACKGROUND OF THE INVENTION

### 1. Field of the Invention

This application claims the benefit of U.S. provisional application No. 63/497,757 filed on Apr. 24, 2023 and U.S. provisional application No. 63/498,855 filed on Apr. 28, 2023.

The present invention relates to video coding, and more particularly, to a video coding method that determines prediction of a current block by jointly considering (e.g., blending) a first data (which is derived from cross-component prediction or luma reference samples) and a second data (which is derived from existing intra chroma prediction or existing inter chroma prediction) and an associated apparatus.

### 2. DESCRIPTION OF THE PRIOR ART

The conventional video coding standards generally adopt a block based coding technique to exploit spatial and temporal redundancy. For example, the basic approach is to divide the whole source picture into a plurality of blocks, perform intra/inter prediction on each block, transform residues of each block, and perform quantization and entropy encoding. Besides, a reconstructed picture is generated in a coding loop to provide reference data used for coding following blocks. For certain video coding standards, in-loop filter(s) may be used for enhancing the image quality of the reconstructed frame.

The video decoder is used to perform an inverse operation of a video encoding operation performed by a video encoder. For example, the video decoder may have a plurality of processing circuits, such as an entropy decoding circuit, an intra prediction circuit, a motion compensation circuit, an inverse quantization circuit, an inverse transform circuit, a reconstruction circuit, and in-loop filter(s).

Typically, the coding efficiency highly depends on accuracy of the prediction. Thus, there is a need for an innovative chroma prediction scheme for improving the prediction accuracy as well as the coding efficiency.

### SUMMARY OF THE INVENTION

One of the objectives of the claimed invention is to provide a video coding method that determines prediction of a current block by jointly considering (e.g., blending) a first data (which is derived from cross-component prediction or luma reference samples) and a second data (which is derived from existing intra chroma prediction or existing inter chroma prediction) and an associated apparatus.

According to a first aspect of the present invention, an exemplary method for video coding is disclosed. The exemplary method includes: receiving data to be encoded or decoded as a current block of pixels of a current picture of a video, wherein the current block comprises a luma block and at least one chroma block; and encoding or decoding the current block by a target prediction mode, including: obtaining a first data, wherein the first data is derived from cross-component prediction of chroma samples of the current block or luma reconstructed samples of the current block; obtaining a second data, wherein the second data is derived from intra chroma prediction of the chroma samples of the current block or inter chroma prediction of the chroma samples of the current block; and determining prediction of the chroma samples of the current block by jointly considering the first data and the second data.

According to a second aspect of the present invention, an exemplary video encoder is disclosed. The exemplary video encoder includes a video data memory and an encoding circuit. The video data memory is arranged to receive data to be encoded as a current block of pixels of a current picture of a video, wherein the current block comprises a luma block and at least one chroma block. The encoding circuit is arranged to perform encoding of the current block by a target prediction mode. The encoding circuit includes a prediction processing circuit. The prediction processing circuit is arranged to obtain a first data, a second data, and determine prediction of chroma samples of the current block by jointly considering the first data and the second data. The first data is derived from cross-component prediction of the chroma samples of the current block or luma reconstructed samples of the current block. The second data is derived from intra chroma prediction of the chroma samples of the current block or inter chroma prediction of the chroma samples of the current block.

According to a third aspect of the present invention, an exemplary video decoder is disclosed. The exemplary video decoder includes a video data memory and a decoding circuit. The video data memory is arranged to receive data to be decoded as a current block of pixels of a current picture of a video, wherein the current block comprises a luma block and at least one chroma block. The decoding circuit is arranged to perform decoding of the current block by a target prediction mode. The decoding circuit includes a prediction processing circuit. The prediction processing circuit is arranged to obtain a first data, a second data, and determine prediction of chroma samples of the current block by jointly considering the first data and the second data. The first data is derived from cross-component prediction of the chroma samples of the current block or luma reconstructed samples of the current block. The second data is derived from intra chroma prediction of the chroma samples of the current block or inter chroma prediction of the chroma samples of the current block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating locations of the samples used for the derivation of α and β according to an embodiment of the present invention.

FIG. 2 is a diagram illustrating a reference area (with its paddings) used to derive the filter coefficients according to an embodiment of the present invention.

FIG. 3 is a diagram illustrating positions of spatial merge candidate according to an embodiment of the present invention.

FIG. 4 is a diagram illustrating spatial neighboring blocks used to derive the spatial merge candidates according to an embodiment of the present invention.

FIG. 5 is a diagram illustrating motion vector scaling for temporal merge candidate according to an embodiment of the present invention.

FIG. 6 is a diagram illustrating candidate positions for temporal merge candidate, C₀ and C₁, according to an embodiment of the present invention.

FIG. 7 is a diagram illustrating top and left neighboring blocks used in CIIP weight derivation according to an embodiment of the present invention.

FIG. 8 is a diagram illustrating a pattern being any subset of a window region M×N around/including the position (iL, jL) according to an embodiment of the present invention.

FIG. 9 is a diagram illustrating a pattern being 5×5 cross, including or not excluding (iL, jL), according to an embodiment of the present invention.

FIG. 10 is a diagram illustrating a pattern being 5×5 diamond, including or not excluding (iL, jL), according to an embodiment of the present invention.

FIG. 11 is a diagram illustrating different Sobel filters according to an embodiment of the present invention.

FIG. 12 is a diagram illustrating a pattern being any subset of a window region M2×N2 around/including the position (iC, jC) according to an embodiment of the present invention.

FIG. 13 is a diagram illustrating a pattern being 5×5 cross, including or not excluding (iC, jC), according to an embodiment of the present invention.

FIG. 14 is a diagram illustrating a pattern being 5×5 diamond, including or not excluding (iC, jC), according to an embodiment of the present invention.

FIG. 15 is a diagram illustrating a spatial neighboring region of the current block that includes above reference region, left reference region, above-left reference region, and/or any subset of the above according to an embodiment of the present invention.

FIG. 16 is a diagram illustrating the to-be-predicted chroma (i, j) according to an embodiment of the present invention.

FIG. 17 is a diagram illustrating scanning orders when adding the spatial model information from spatial neighbor blocks into the list according to an embodiment of the present invention.

FIG. 18 is a diagram illustrating that inter-predictor of regular merge mode is refined using the above R_{x,-1} and left R_{-1,y} reconstructed samples according to an embodiment of the present invention.

FIG. 19 is a diagram illustrating an example of the right-bottom region for the current chroma block according to an embodiment of the present invention.

FIG. 20 is a diagram illustrating that a boundary matching cost for a candidate mode refers to the discontinuity measurement (including top boundary matching and/or left boundary matching) between the current prediction (the predicted samples within the current block), generated from the candidate mode, and the neighboring reconstruction (the reconstructed samples within one or more neighboring blocks) according to an embodiment of the present invention.

FIG. 21 is a block diagram illustrating a video encoder that supports the proposed prediction mode with chroma prediction improvement according to an embodiment of the present invention.

FIG. 22 is a block diagram illustrating a video decoder that supports the proposed prediction mode with chroma prediction improvement according to an embodiment of the present invention.

FIG. 23 is a flowchart illustrating a video coding method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

### Acronyms

CCLM: Cross Component Linear Model
MMLM: Multiple model CCLM
LM: Linear Model
MV: Motion Vector
CU: Coding Unit
CB: Coding Block
CTU: Coding Tree Unit
VVC: Versatile Video Coding
SAO: Sample Adaptive Offset
ALF: Adaptive Loop Filtering
IBC: Intra Block Copy
MRL: Multiple reference line
ISP: Intra sub-partitions
MIP: Matrix weighted Intra Prediction
JCCR: Joint Coding of Chroma Residual
   Intra Mode Coding with 67 Intra Prediction Modes

To capture the arbitrary edge directions presented in natural video, the number of directional intra modes in VVC is extended from 33, as used in HEVC, to 65.

To keep the complexity of the most probable mode (MPM) list generation low, an intra mode coding method with 6 MPMs is used by considering two available neighboring intra modes. The following three aspects are considered to construct the MPM list:
Default intra modes
Neighbouring intra modes
Derived intra modes

### Multiple Reference Line (MRL) Intra Prediction

Multiple reference line (MRL) intra prediction uses more reference lines for intra prediction.

### Intra Sub-Partitions

The intra sub-partitions (ISP) divides luma intra-predicted blocks vertically or horizontally into 2 or 4 sub-partitions depending on the block size.

The reconstructed sample values of each sub-partition are available to generate the prediction of the next sub-partition, and each sub-partition is processed consecutively. In addition, the first sub-partition to be processed is the one containing the top-left sample of the CU and then continuing downwards (horizontal split) or rightwards (vertical split).

### Matrix Weighted Intra Prediction

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation.

### Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , 1 ) + β \qquad ( 1 )$$

where pred_{c}(i,j) represents the predicted chroma samples in a CU and rec_{L}′(i, j) represents the downsampled reconstructed luma samples of the same or collocated CU.

The CCLM parameters (α and β) are derived with at most four neighbouring chroma samples and their corresponding down-sampled luma samples. Suppose the current chroma block dimensions are W×H, then W″ and H′ are set as
W′=W, H′=H when LM_LA mode is applied;
W′=W+H when LM_A mode is applied;
H′=H+W when LM_L mode is applied;

The above neighbouring positions are denoted as S[0,−1] . . . S[W′−1,−1] and the left neighbouring positions are denoted as S[−1, 0] . . . S[−1, H′−1]. Then the four samples are selected as
S[W′/4,−1], S[3*W′/4,−1], S[−1, H′/4], S[−1, 3*H′/4] when LM_LA mode is applied and both above and left neighbouring samples are available;
S[W′/8,−1], S[3*W′/8,−1], S[5*W′/8,−1], S[7*W′/8,−1] when LM_A mode is applied or only the above neighbouring samples are available;
S[−1, H′/8], S[−1, 3*H′/8], S[−1, 5*H′/8], S[−1, 7*H′/8] when LM_L mode is applied or only the left neighbouring samples are available;

The four neighbouring luma samples at the selected positions are down-sampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then x_{A}, x_{B}, y_{A} and y_{B} are derived as:

$${X}_{a} = ( {x}_{A}^{0} + {x}_{A}^{1} + 1 ) >> 1 ; {X}_{b} = ( {x}_{B}^{0} + {x}_{B}^{1} + 1 ) >> 1 ; \qquad ( 2 )$$

$${Y}_{a} = ( {y}_{A}^{0} + {y}_{A}^{1} + 1 ) >> 1 ; {Y}_{b} = ( {y}_{B}^{0} + {y}_{B}^{1} + 1 ) >> 1$$

Finally, the linear model parameters α and β are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b} \qquad ( 4 )$$

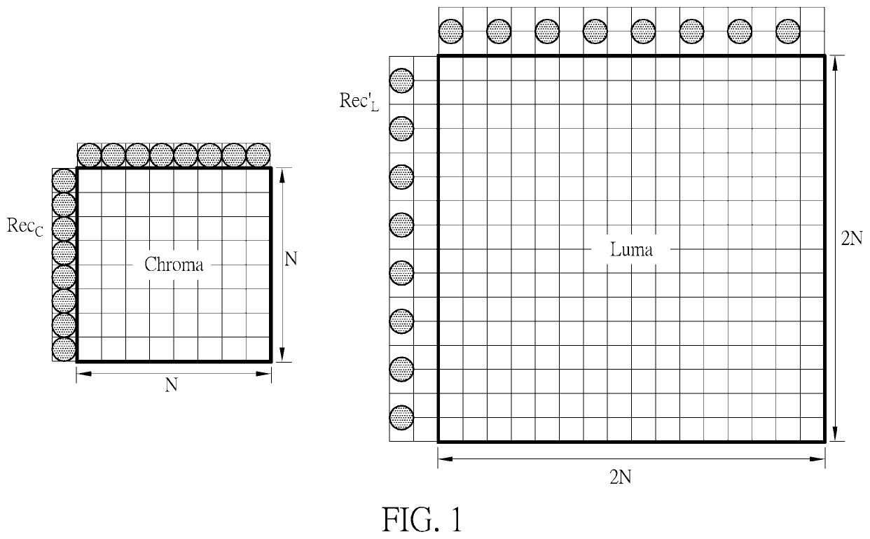

FIG. 1 shows an example of the location of the left and above samples and the sample of the current block involved in the LM_LA mode.

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables

Besides the above template and left template can be used to calculate the linear model coefficients together, they also can be used alternatively in the other 2 LM modes, called LM_A, and LM_L modes.

In LM_A mode, only the above template are used to calculate the linear model coefficients. To get more samples, the above template is extended to (W+H) samples. In LM_L mode, only left template are used to calculate the linear model coefficients. To get more samples, the left template is extended to (H+W) samples.

In LM_LA mode, left and above templates are used to calculate the linear model coefficients.

### Multiple Model CCLM

In the JEM, multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular a and 6 are derived for a particular group). Furthermore, the samples of the current luma block are also classified based on the same rule for the classification of neighbouring luma samples.

Threshold is calculated as the average value of the neighbouring reconstructed luma samples. A neighbouring sample with Rec′[x,y]<=Threshold is classified into group 1; while a neighbouring sample with Rec′_{L}[[x,y]>Threshold is classified into group 2.

$$\{ \begin{matrix}{Pred}_{C} [ x , y ] = {α}_{1} \times {Rec}_{L}^{′} [ x , y ] + {β}_{1} & if {Rec}_{L}^{′} [ x , y ] \leq Threshold \\ {Pred}_{C} [ x , y ] = {α}_{2} \times {Rec}_{L}^{′} [ x , y ] + {β}_{2} & if {Rec}_{L}^{′} [ x , y ] > Threshold\end{matrix} \qquad ( 6 )$$

### Convolutional Cross-Component Model (CCCM)

In CCCM, a convolutional model is applied to improve the chroma prediction performance.

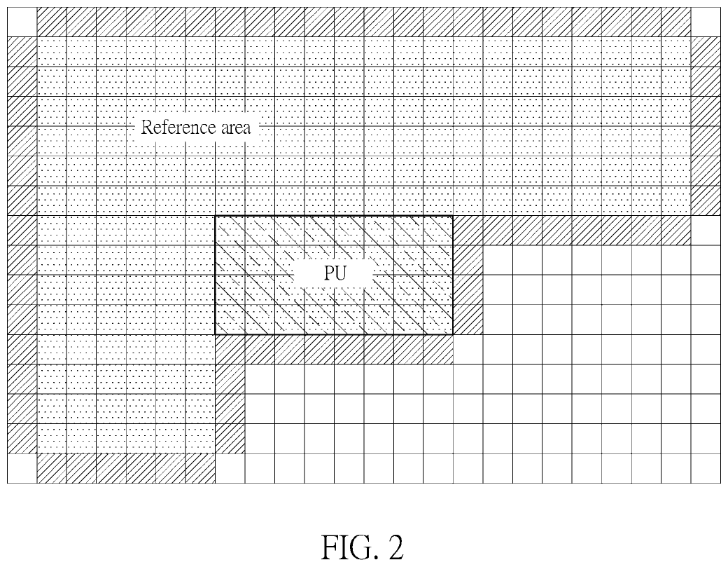

The filter coefficients are calculated by minimising MSE between predicted and reconstructed chroma samples in the reference area. FIG. 2 illustrates the reference area which consists of 6 lines of chroma samples above and left of the PU. Reference area extends one PU width to the right and one PU height below the PU boundaries. Area is adjusted to include only available samples. The extensions to the area shown in slash are needed to support the “side samples” of the plus shaped spatial filter and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM (enhanced compression model), however LDL decomposition was chosen instead of Cholesky decomposition to avoid using square root operations.

### Gradient Linear Model (GLM)

Compared with the CCLM, instead of down-sampled luma values, the GLM utilizes luma sample gradients to derive the linear model.

### Intra Block Copy

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture.

### Chroma DM Mode

For Chroma DM mode, the intra prediction mode of the corresponding (collocated) luma block covering the center position of the current chroma block is directly inherited.

### Decoder Side Intra Mode Derivation (DIMD)

When DIMD is applied, two intra modes are derived from the reconstructed neighbor samples, and those two predictors are combined with the planar mode predictor with the weights derived from the gradients. The DIMD mode is used as an alternative prediction mode and is always checked in the high-complexity RDO mode.

To implicitly derive the intra prediction modes of a blocks, a texture gradient analysis is performed at both encoder and decoder sides. This process starts with an empty Histogram of Gradient (HoG) with 65 entries, corresponding to the 65 angular modes. Amplitudes of these entries are determined during the texture gradient analysis.

### Template-Based Intra Mode Derivation (TIMD)

Template-based intra mode derivation (TIMD) mode implicitly derived the intra prediction mode of a CU by a neighboring template at both encoder and decoder, instead of being signal exact intra prediction mode bits to the decoder. The prediction samples of the template are generated using the reference samples of the template for each candidate mode. A cost is calculated as the SATD between the prediction and the reconstruction samples of the template. The intra prediction mode with the minimum cost is selected as the TIMD mode similar to the mode derivation method for DIMD mode and used for intra prediction of the CU.

### Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

### Inter Prediction Overview (More Details can be Found in JVET-T2002 Section 3.4.)

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16th luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

The following text provides the details on those inter prediction methods specified in VVC.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in the following sessions. As done in HEVC, VVC also supports parallel derivation of the merge candidate lists (or called as merging candidate lists) for all CUs within a certain size of area.

### Spatial Candidates Derivation

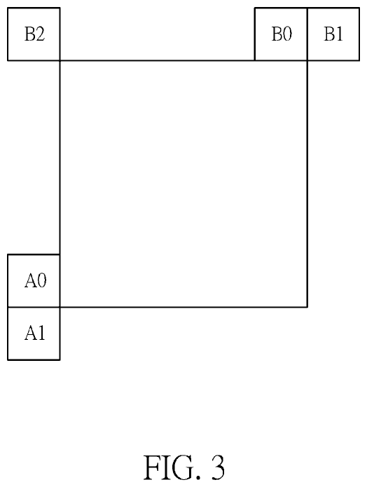

The derivation of spatial merge candidates in VVC is same to that in HEVC except the positions of first two merge candidates are swapped. A maximum of four merge candidates are selected among candidates located in the positions depicted in FIG. 3. The order of derivation is B0, A0, B1, A1 and B2. Position B2 is considered only when one or more than one CUs of position B0, A0, B1, A1 are not available (e.g. because it belongs to another slice or tile) or is intra coded. After candidate at position A1 is added, the addition of the remaining candidates is subject to a redundancy check which ensures that candidates with same motion information are excluded from the list so that coding efficiency is improved.

In addition to the above-mentioned spatial candidates, the non-adjacent spatial merge candidates as in JVET-L0399 are inserted after the TMVP in the regular merge candidate list.

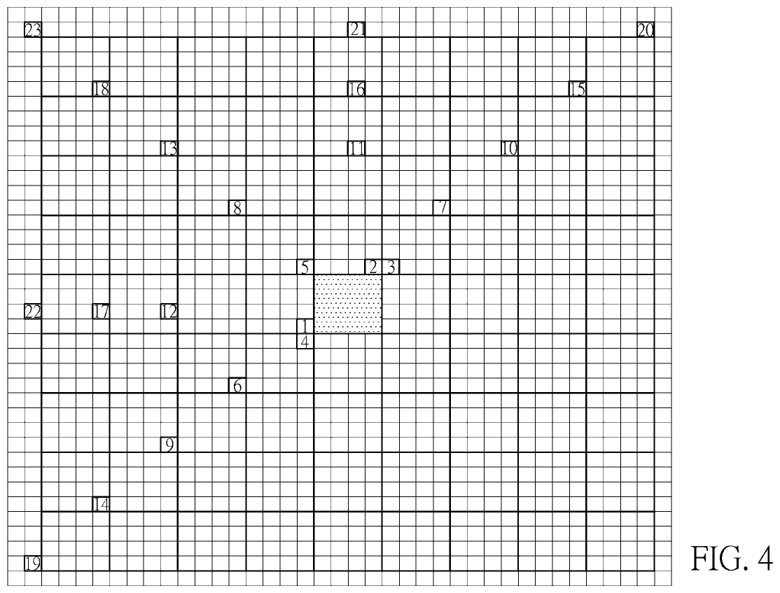

The pattern of non-adjacent spatial merge candidates is shown in FIG. 4. The distances between non-adjacent spatial candidates and current coding block are based on the width and height of current coding block. The line buffer restriction is not applied.

### Temporal Candidates Derivation

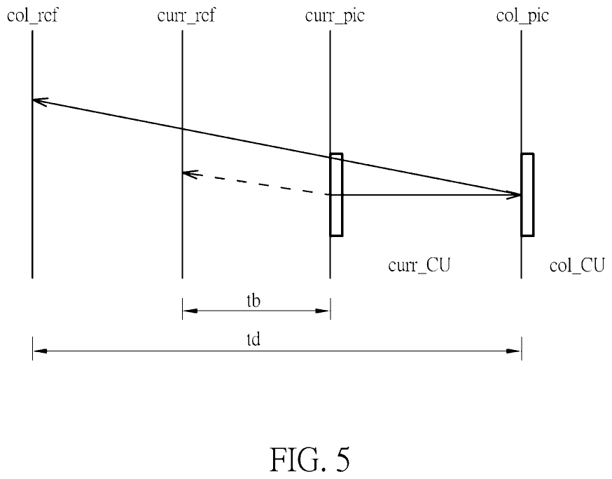

In this step, only one candidate is added to the list. Particularly, in the derivation of this temporal merge candidate, a scaled motion vector is derived based on co-located CU belonging to the collocated reference picture. The reference picture list and the reference index to be used for derivation of the co-located CU is explicitly signalled in the slice header. The scaled motion vector for temporal merge candidate is obtained as illustrated by the dotted line in FIG. 5, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

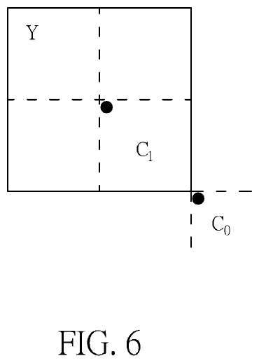

The position for the temporal candidate is selected between candidates C0 and C1, as depicted in FIG. 6. If CU at position C0 is not available, is intra coded, or is outside of the current row of CTUs, position C1 is used. Otherwise, position C0 is used in the derivation of the temporal merge candidate.

### History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.

### Pair-Wise Average Merge Candidates Derivation

Pairwise average candidates are generated by averaging predefined pairs of candidates in the existing merge candidate list, using the first two merge candidates.

When the merge list is not full after pair-wise average merge candidates are added, the zero MVPs are inserted in the end until the maximum merge candidate number is encountered.

### Combined Inter and Intra Prediction (CIIP)

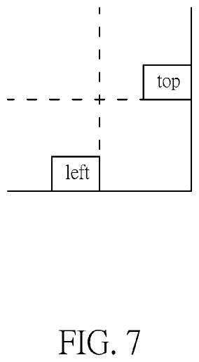

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pinter is derived using the same inter prediction process applied to regular merge mode; and the intra prediction signal Pᵢₙₜᵣₐ is derived following the regular intra prediction process with the planar mode or TIMD. Then, the intra and inter prediction signals are combined using weighted averaging, where the weight value is calculated depending on the coding modes of the top and left neighbouring blocks (depicted in FIG. 7) as follows:
If the top neighbor is available and intra coded, then set isIntraTop to 1, otherwise set isIntraTop to 0;
If the left neighbor is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{inter} + wt * {P}_{intra} + 2 ) ≫ 2 \qquad ( 7 )$$

### Spatial GPM (More Details can be Found in JVET-Z0124.)

Similar to inter GPM, Spatial GPM (SGPM) consists of one partition mode and two associated intra prediction modes. If these modes are directly signaled in the bit-stream, it would yield significant overhead bits. To express the necessary partition and prediction information more efficiently in the bit-stream, a candidate list is employed and only the candidate index is signaled in the bit-stream. Each candidate in the list can derive a combination of one partition mode and two intra prediction modes.

### OBMC (More Details can be Found in JVET-W2025.)

When OBMC is applied, top and left boundary pixels of a CU are refined using neighboring block's motion information with a weighted prediction as described in JVET-L0101.

### Proposed Invention

### Cross-Component Information to Improve Prediction Accuracy of the Current Block

The current block (for example, CU) is viewed as an inter CU, intra CU, or a new type of prediction mode (neither intra nor inter). In one embodiment, LM assisted Angular/Planar Mode is proposed and can be modified using several embodiments. In another embodiment, inter prediction is modified using cross-component information. The following takes the current block as inter for example. To improve the prediction accuracy of the chroma component of the inter block, the luma information from the corresponding luma component and/or the chroma information from the previous coded chroma component are used.
The first scheme is that for a coding unit (under single tree splitting) including luma (Y) and chroma (Cb and/or Cr) components, the prediction for Cb and/or Cr is improved by using the information from Y.
The second scheme is that for a coding unit (under single tree splitting) including luma (Y) and chroma (Cb and/or Cr) components or for a coding unit (under chroma dual tree splitting) including chroma (Cb and/or Cr) components, the prediction for Cr is improved by using the information from Cb. For example, deriving model parameters by using neighboring reconstructed samples of cb and cr as the inputs X, which is used to predict Cr when deriving the model for cross-component prediction, and Y, which is used as the target when deriving the model for cross-component prediction, of model derivation. Then generating cr prediction by the derived model parameters and cb reconstructed samples.

In the following, several embodiments related to the first scheme are proposed to (1) determine self-derived candidates or inherited candidates using building a candidate list (or set) for the current block where the candidate list (or set) includes cross-component models (2) select one or more model information in the list (or set) or use one or more self-derived candidates and (3) use the model information (similar to intra chroma cross-component mode) to generate one or more hypotheses of predictions for the current chroma component (Cb or Cr) by applying and/or modifying the selected model information to the reconstructed or predicted samples for the corresponding luma component. For modifying inter prediction, when the selected model information refers to traditional cross-component linear model(s), the proposed method is called as inter cross-component linear model (inter CCLM) mode. When the selected model information refers to convolutional cross-component model(s) derived by a regression-based method (as CCCM for example), the proposed method is called as inter cross-component convolution model (inter CCCM) mode. For modifying non-inter prediction (for example, the intra prediction using traditional intra prediction modes and the cross-component modes), the selected model for the cross-component modes can be from one or more inherited candidates and/or one or more self-derived candidates.

The proposed embodiments can also be used for the second scheme by using the previous coded chroma component (Cb) as the luma component in the first scheme.

### 1. Self-Derived Cross-Component Candidates

The cross-component prediction (containing target predicted samples) of the current bock is formed by combining one or more proposed source terms and the models (referring to a proposed weighting setting). As shown in the expression (8), pred (i, j) is a target (predicted) sample in the current block which can be obtained after the proposed mechanism, sourceTermSet includes one or more source terms from luma component, sourceTermSet1 includes one or more source terms from chroma components, and biasTermSet includes one or more bias terms.

The expression (8) is just an example and the proposed mechanism can use any subset or extension of sourceTermSet0, sourceTermSet1, and biasTermSet. Each sample or any subset of samples in the current block gets its target (predicted) sample according to the expression (8). In the following, the content of sourceTermSet0 is described in Section 1.1, the content of sourceTermSet1 is described in Section 1.2, the content of biasTermSet is described in Section 1.3, and the predictor derivation using the proposed source terms and the proposed weighting setting is described in Section 1.4. Several examples with the proposed mechanism are shown in Section 1.4.

$$pred ( i , j ) = ( sourceTermSet 0 ( i , j ) + sourceTermSet 1 ( i , j ) + … + biasTermSet ) \qquad ( 8 )$$

$$with the proposed weighting setting where ( i , j ) is a sample postion in the current block .$$

1.1. Content of sourceTermSet0 (i, j)

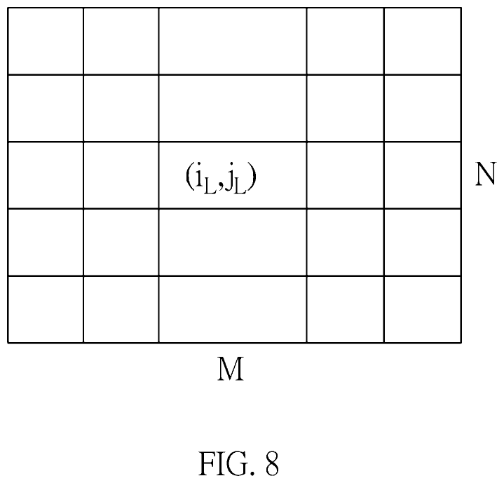

SourceTermSet0 (i, j) includes one or more luma source terms denoted as sourceTerm0₀, sourceTerm0₁, . . . , and/or sourceTerm0ₙ₋₁. The value of n means the number of taps for the source term set. In one embodiment, the source terms can be linear terms and/or non-linear terms, only linear terms, and/or only non-linear terms. In another embodiment, n is a pre-defined value such as 1, 2, . . . or any positive integer. For example, the pre-defined value is fixed in the standard. For another example, the pre-defined value is smaller than or equal to a maximum threshold indicated by a syntax in the bitstream where the syntax is at block, CTU, CTB, slice, tile, picture, SPS, PPS, picture, and/or sequence level. In another embodiment, n is determined by coding information of the current block and/or sample position (i, j). For example, when the current block is coded by a specific coding tool, n is (1) fixed at a pre-defined value, (2) determined according to block width, block height, block area, coding information and/or sample information for the current block, (3) determined according to coding information and/or sample information for the adjacent/non-adjacent spatial neighboring reference region of the current block, and/or (4) determined according to coding information and/or sample information for the temporal reference region of the current block. In another embodiment, the pattern of the n taps refers to a pattern defined as any subset of a window region M×N around and/or including the position (i_{L}, j_{L}), as illustrated in FIG. 8. That is, (i_{L}, j_{L}) is used to derive the window and/or the pattern which means one or more to-be-used positions. For example, (i_{L}, j_{L}), is one of the to-be-used samples. For example, (i_{L}, j_{L}), is not one of the to-be-used samples. For some examples, (i_{L}, j_{L}) refers to the center of the window and/or the pattern. However, (i_{L}, j_{L}) is not limited to referring to the center of the window and/or the pattern. If the target sample is luma, (i_{L},j_{L}) is (i, j). If the target sample is chroma (e.g., cb or cr), (i_{L}, j_{L}) is the collocated luma position from (i, j).

For one example, (i_{L},j_{L}) refers to the center of the window and only the center (i_{L},j_{L}) of the window is used.

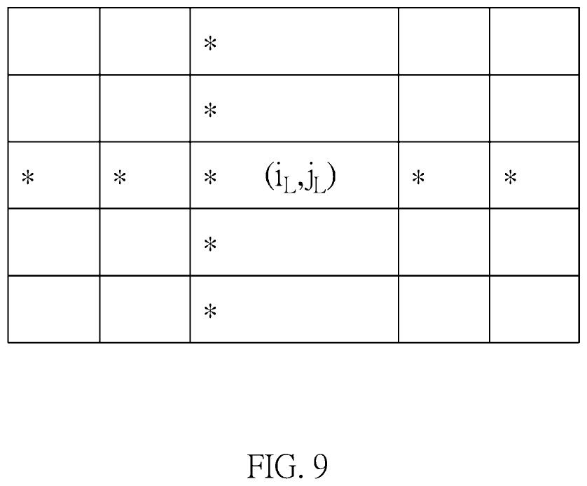

For another example of the pattern being 5×5 cross: (i_{L},j_{L}) refers to the center of the window which may be including or not excluding (i_{L},j_{L}), as illustrated in FIG. 9.

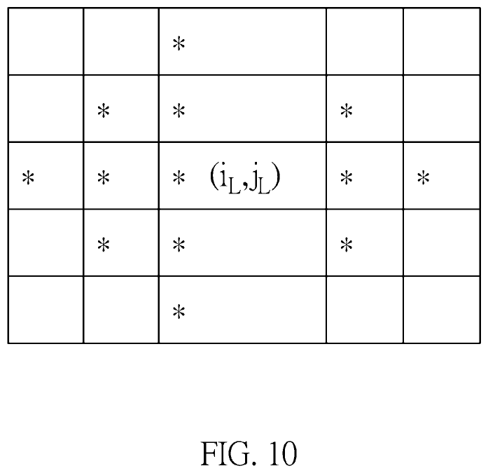

For another example of the pattern being 5×5 diamond: (i_{L},j_{L}) refers to the center of the window which may be including or not excluding (i_{L}, j_{L}), as illustrated in FIG. 10.

In another embodiment, different taps refer to the source terms from different prediction modes or different mode types. In one sub-embodiment, one or more taps are from mode type intra, another one or more taps are from mode type inter, and/or another one or more taps are from mode type IBC. In another sub-embodiment, one or more taps are from MIP intra prediction modes, another one or more taps are from non-MIP intra prediction modes.

For a source term in the source term set, the following embodiments are used to determine generation of source content.

In one embodiment, the source content is based on a predicted sample generated by a prediction mode and/or a reconstructed sample generated based on the predicted sample by a prediction mode and a reconstructed residual. For an example to generate cross-component prediction for chroma using a model, the source content, which can be viewed as the input of the model such as the reconstruction from the corresponding luma, is combined or multiplied with the weighting, which can be viewed as the model parameters, to derive the cross-component prediction for chroma.

In one sub-embodiment, the prediction mode belongs to mode type intra, mode type inter, or a third mode type (e.g., mode type IBC). For an example of the prediction mode belonging to mode type intra, the prediction mode refers to planar, DC, horizontal, vertical, other angular (directional) prediction mode, any intra prediction modes specified in 67/131 intra prediction mode domain, wide-angle intra prediction (WAIP) modes, TIMD derived modes, DIMD derived modes, intraTMP, and/or any intra prediction modes specified in the standard. For another example of the prediction mode belonging to mode type inter, the prediction mode refers to skip mode, regular merge modes, MMVD modes, affine modes, SbTMVP, AMVR, any merge mode specified in the standard, any AMVP (where AMVP can be called as non-merge inter or advanced MVP) mode specified in the standard, or any inter mode specified in the standard. For another example of the prediction mode belonging to mode type IBC, the prediction mode refers to IBC merge, IBC AMVP, or any IBC mode specified in the standard. Note that any possible combination between the prediction mode and the mode type is supported in this invention. That is, any mentioned prediction mode can be under any mode type according to the standard definition. For example, following the standard definition, if IBC mode belongs to mode type inter, the prediction mode belongs to mode type inter in the embodiments can refer to an IBC mode.

In another sub-embodiment, the source content is the filtered source or the source with any pre-processing. For example, the source content is the predicted/reconstructed sample after filtering with a pre-defined model or filter. For an example to generate cross-component prediction for chroma using a model, the source content, which can be viewed as the input of the model such as the reconstruction from the corresponding luma, is filtered using downsampling filters or gradient filters.

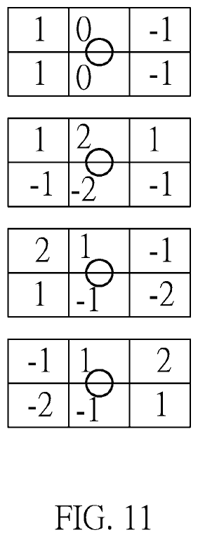

In another sub-embodiment, the source content is gradient information from the predicted samples and/or reconstructed samples. If the target sample (i, j) belongs to chroma and gradient information of the collocated luma sample (as the center circle) is calculated with any one of the following Sobel filters illustrated in FIG. 11 or any pre-defined filter. Each value around the center circle is multiplied with the corresponding predicted/reconstructed samples in the collocated luma block and then added with each other to form the gradient information for the source term of the target sample (i, j).

In another sub-embodiment, since the target sample belongs to a chroma sample (e.g., cb or cr)), the predicted sample and/or the reconstructed sample is located within the collocated (luma) block from the current (chroma) block. The predicted sample and/or the reconstructed sample is treated as an initial sample and used as source content to generate the target sample.

In another embodiment, the values of the source terms are further adjusted (added or subtracted) by a pre-defined offset. If the target sample refers to chroma, several embodiments are used to generate the offset of the source term. In one sub-embodiment, the offset is determined as the averaging value of each (or any subset of) predicted or reconstructed samples in the collocated luma block from the current (chroma) block or in the reference region of the collocated luma block. In another sub-embodiment, the offset is determined as a sample value of a pre-defined prediction or reconstruction samples in the collocated luma block or in the reference region of the collocated luma block. For example, the sample value is from the top-left position (just outside of the top-left corner of the collocated luma block).

In another embodiment, the source term may further include location information. For example, if the target sample refers to luma, the horizontal location (i) of (i, j) is used in a source term and the vertical location (j) of (i, j) is used in a source term; Otherwise, the horizontal location of the collocated luma block from the sample (i, j) is used in a source term and the vertical location of the collocated luma block from the sample (i, j) is used in a source term.

In another embodiment, the source term may further include location information. For example, if the target sample refers to chroma, the horizontal location of the collocated luma from the sample (i, j) is used in a source term, and the vertical location of the collocated luma from the sample (i, j) is used in a source term.

1.2. Content of sourceTermSet1 (i, j)

SourceTermSet1 (i, j) includes one or more chroma (cb or cr) source terms denoted as sourceTerm1₀, sourceTerm1₁, . . . , and/or sourceTerm1ₘ₋₁. The value of m means the number of taps for the source term set. In one embodiment, the source terms can be linear terms and/or non-linear terms, only linear terms, and/or only non-linear terms. In another embodiment, m is a pre-defined value such as 1, 2, . . . or any positive integer. For example, the pre-defined value is fixed in the standard. For another example, the pre-defined value is smaller than or equal to a maximum threshold indicated by a syntax in the bitstream where the syntax is at block, CTU, CTB, slice, tile, picture, SPS, PPS, picture, and/or sequence level.

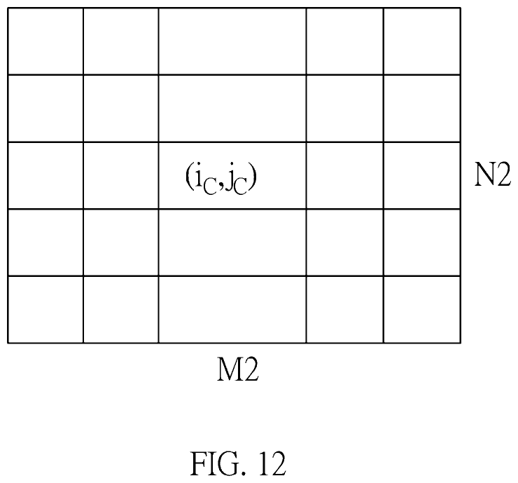

In another embodiment, m is determined by coding information of the current block and/or sample position (i, j). For example, when the current block is coded by a specific coding tool, m is (1) fixed at a pre-defined value, (2) determined according to block width, block height, block area, coding information and/or sample information for the current block, (3) determined according to coding information and/or sample information for the adjacent/non-adjacent spatial neighboring reference region of the current block, and/or (4) determined according to coding information and/or sample information for the temporal reference region of the current block. In another embodiment, the pattern of the m taps refers to a pattern defined as any subset of a window region M2×N2 around and/or including the position (i_{c}, j_{c}), as illustrated in FIG. 12. That is, (i_{c}, j_{c}) is used to derive the window and/or the pattern which means one or more to-be-used positions. For example, (i_{c}, j_{c}), is one of the to-be-used samples. For example, (i_{c}, j_{c}), is not one of the to-be-used samples. For some examples, (i_{c}, j_{c}) refers to the center of the window and/or the pattern. However, (i_{c}, j_{c}) is not limited to referring to the center of the window and/or the pattern. If the target sample is chroma (cb or cr), (i_{c},j_{c}) is (i, j). If the target sample is luma, (i_{c}, j_{c}) is the collocated chroma position from (i, j).

For one example, (i_{c},j_{c}) refers to the center of the window and only the center (i_{c},j_{c}) of the window is used.

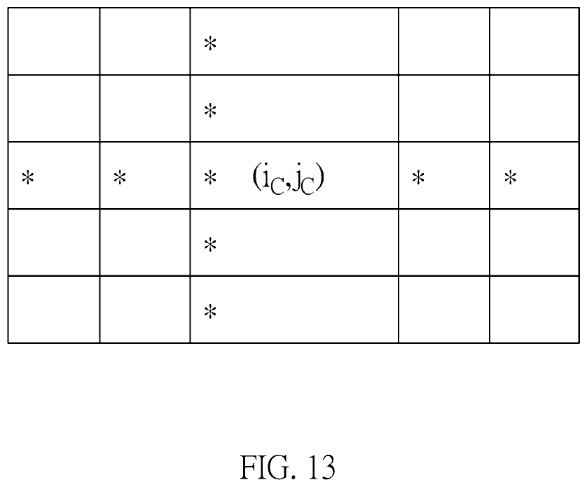

For another example of the pattern being 5×5 cross: (i_{c},j_{c}) refers to the center of the window which may be including or not excluding (i_{c},j_{c}), as illustrated in FIG. 13.

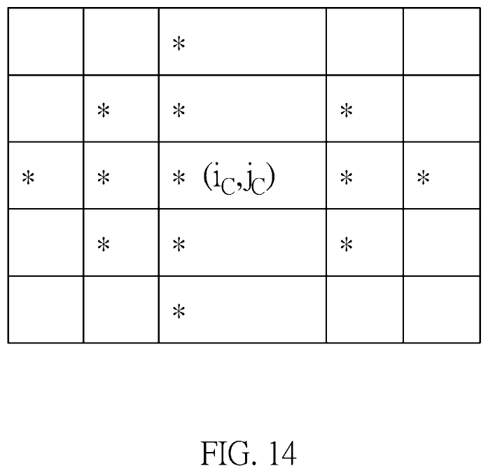

For another example of the pattern being 5×5 diamond: (i_{c},j_{c}) refers to the center of the window which may be including or not excluding (i_{c},j_{c}), as illustrated in FIG. 14.

In another embodiment, different taps refer to the source terms from different prediction modes or different mode types. In one sub-embodiment, one or more taps are from mode type intra, another one or more taps are from mode type inter, and/or another one or more taps are from mode type IBC. In another sub-embodiment, one or more taps are from MIP intra prediction modes, another one or more taps are from non-MIP intra prediction modes.

For a source term in the source term set, the following embodiments are used to determine generation of source content.

In one embodiment, the source content is based on a predicted sample generated by a prediction mode and/or a reconstructed sample generated based on the predicted sample by a prediction mode and a reconstructed residual.

In one sub-embodiment, the prediction mode belongs to mode type intra, mode type inter, or a third mode type (e.g. mode type IBC). For an example of the prediction mode belonging to mode type intra, the prediction mode refers to planar, DC, horizontal, vertical, other angular (directional) prediction mode, any intra prediction modes specified in 67/131 intra prediction mode domain, wide-angle intra prediction (WAIP) modes, TIMD derived modes, DIMD derived modes, intraTMP, DBV (direct block vector which refers to a chroma prediction mode and if one of the collocated luma blocks is coded with IBC mode or IntraTMP mode, the (chroma) block vector of this chroma prediction mode is derived according to the block vector for the collocated luma block), any one of cross-component modes (CCLM (including CCLM_LT, CCLM_L, and/or CCLM_T), MMLM (including MMLM_LT, MMLM_L, and/or MMLM_T), CCCM (including CCCM_LT, CCCM_L, and/or CCCM_T), GLM, and/or any variation/extension of the above modes), and/or any intra prediction modes specified in the standard. For another example of the prediction mode belonging to mode type inter, the prediction mode refers to skip mode, regular merge modes, MMVD modes, affine modes, SbTMVP, AMVR, any merge mode specified in the standard, any AMVP mode specified in the standard, or any inter mode specified in the standard. For another example of the prediction mode belonging to mode type IBC, the prediction mode refers to IBC merge, IBC AMVP, or any IBC mode specified in the standard. Note that any possible combination between the prediction mode and the mode type is supported in this invention. That is, any mentioned prediction mode can be under any mode type according to the standard definition. For example, following the standard definition, if IBC mode belongs to mode type inter, the prediction mode belongs to mode type inter in the embodiments can refer to an IBC mode. In one embodiment, DBV can be viewed as using IBC to generate chroma predicted samples.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples. If the target sample (i, j) belongs to luma and gradient information of the collocated chroma sample is calculated with any one of the Sobel filters or any pre-defined filter.

In another sub-embodiment, if the target sample belongs to a chroma sample, the predicted sample and/or the reconstructed sample is located within the current block. The predicted sample and/or the reconstructed sample is treated as an initial sample and used as source content to generate the target sample.

In another embodiment, the values of the source terms are further adjusted (added or subtracted) by a pre-defined offset. If the target sample refers to chroma, several embodiments are used to generate the offset of the source term. In one sub-embodiment, the offset is determined as the averaging value of each (or any subset of) predicted or reconstructed samples in the current block or in the reference region of the current block. In another sub-embodiment, the offset is determined as a sample value of a pre-defined prediction or reconstruction samples in the current block or in the reference region of the current block. For example, the sample value is from the top-left position (just outside of the top-left corner of the current block).

In another embodiment, the source term may further include location information. For example, if the target sample refers to chroma, the horizontal location (i) of (i, j) is used in a source term and the vertical location (j) of (i, j) is used in a source term.

1.3. Content of biasTermSet

Bias term is a pre-defined value. In one embodiment, the bias term is a midValue according to bitDepth specified in the standard. For example, the bias term is set as (1<<(bitDepth-1)). In another embodiment, the bias term is the same for each sample in the current block. That is, the bias term is regardless of the position (i, j).

### 1.4. Predictor Derivation for Sample (i, j)

### 1.4.1. Proposed Weighting Setting

The proposed weighting setting is to estimate the relationship (for example, minimizing the distortion) between “the predicted and/or reconstructed samples on the reference region of the current (chroma) block” and “the predicted and/or reconstructed samples on the reference region of the corresponding luma block” by a pre-defined regression method, to generate a weighting (referring to model parameters) according the regression method, and then to apply the weighting on the source terms to get the target (predicted) samples in the current block. For example, the proposed weighting setting is to estimate the relationship (for example, minimizing the distortion) between “the reconstructed samples on the reference region of the current (chroma) block” and “the combining results of those source terms which use reconstructed samples on the reference region of the corresponding luma block” by a pre-defined regression method, to generate a weighting (referring to model parameters) according to the regression method, and then to apply the weighting on the source terms which use reconstructed samples on the corresponding luma block to get the target (predicted) samples in the current (chroma) block. In one embodiment, the pre-defined regression method can be linear minimum mean square error (LMMSE) method as cross-component modes, for example, CCLM or can be any unified method with the regression method used for cross-component modes, for example, CCLM. In another embodiment, the pre-defined regression method can be the LDL decomposition method as CCCM or can be any unified method with the regression method used for CCCM. In another embodiment, the pre-defined regression method can be Gaussian elimination.

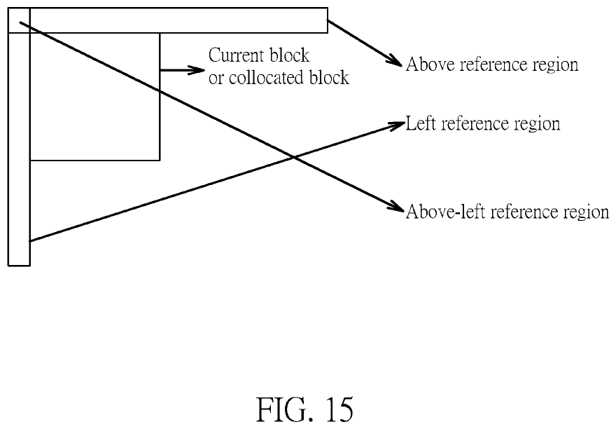

In one embodiment, the reference region of the current block is the spatial adjacent or nonadjacent neighboring region of the current block. The spatial neighboring region of the current block (as template of the current block) includes above reference region, left reference region, above-left reference region, and/or any subset of the above-mentioned regions, as illustrated in FIG. 15. The size of the above reference region is A_{W}×A_{H}, the size of the left reference region is L_{W}×L_{H}, and the size of the above-left reference is AL_{W}×AL_{H}, where
A_{W}=block width of the current block (W), k*W, W+block height of the current block (H), any pre-defined value, or any adaptive value depending on the block position, block width, block height, and/or block area of the current block.
A_{H} or AL_{H}=H, any pre-defined value (1, 2, 4, . . . ), or any adaptive value depending on the block position, block width, block height, and/or block area of the current block.
L_{W} or AL_{W}=W, any pre-defined value (1, 2, 4, . . . ), or any adaptive value depending on the block position, block width, block height, and/or block area of the current block.
L_{H}=H, k*H, H+W, any pre-defined value, or any adaptive value depending on the block position, block width, block height, and/or block area of the current block.

The reference region of the corresponding luma block is the spatial neighboring region of the corresponding luma block.

In another embodiment, the reference region of the current block is the vector-collocated region of the current block and the reference region of the corresponding luma block is the vector-collocated region of the corresponding luma block. The vector-collocated region is a region indicated using a vector in a pre-defined picture which can be a reference picture or a collocated picture. In one embodiment, for inter coding unit containing luma and chroma blocks, the vector-collocated region of the current block refers to the motion compensated results by using the motion information (motion vectors and/or reference pictures) of the current block, and the vector-collocated region of the corresponding luma block refers to the motion compensated results by using the motion information (motion vectors and/or reference pictures) of the corresponding luma block. For IBC or intraTMP (or named as TMP), the vector-collocated region of the current block refers to the motion compensated results (specifically, block compensated results) by using the motion information (specifically, the block information as block vectors and/or current picture) of the current block, and the vector-collocated region of the corresponding luma block refers to the motion compensated results (specifically, block compensated results) by using the motion information (specifically, the block information as block vectors and/or current picture) of the corresponding luma block.

In another embodiment, the above-proposed two kinds of the reference region (for example, the reference region includes the one or more templates and a pre-defined region indicated using a vector) of the current block can be used together. For example, generally, samples in the vector-collocated region of the current block are used as input samples when deriving model parameters; however, for a smaller block, samples in the spatial neighboring reference region (for example, a template) are used as additional input samples when deriving model parameters.

### 1.4.2. Different Example Expressions

1.4.2.1.

$${pred}_{C} ( i , j ) = {α}_{0} \cdot G ( i , j ) + {α}_{1} \cdot {rec}_{L}^{′} ( i , j ) + {α}_{2} \cdot bias$$

In this expression of the target sample being chroma, sourceTermSet0 includes two taps as G(i, j) and rec′_{L}(i, j), sourceTermSet1 is not used, and biasTerm refers to another one tap as midValue. (i,) is the gradient information generated from a selected gradient filter and rec′_{L}(i, j) is down-sampled reconstructed luma sample. The model parameters (a0, a1, and a2) of the weighting are derived based on:
Using six rows and columns adjacent samples as the reference region of the current block
Using the LDL decomposition method as the regression method
   1.4.2.2.

$${pred}_{C} ( i , j ) = {α}_{0} \cdot C + {α}_{1} \cdot Gy ( i , j ) + {α}_{2} \cdot Gx ( i , j ) + {α}_{3} \cdot Y ( i , j ) + {α}_{4} \cdot X ( i , j ) + {α}_{5} \cdot P ( i , j ) + {α}_{6} \cdot bias$$

In this expression (similar to JVET-AC0054) of the target sample being chroma, sourceTermSet0 includes six taps as C (the collocated/corresponding luma reconstructed sample), Gy(i, j), Gx(i, j), Y, X, and P (for example, a non-linear term as CCCM), sourceTermSet1 is not used, and biasTerm refers to another one tap as midValue.
Gy(i,j) is the gradient information generated from a vertical gradient filter.
Gx(i,j) is the gradient information generated from a horizontal gradient filter.
Y and X are the vertical and horizontal locations of the collocated luma sample.
Using six rows and columns adjacent samples as the reference region of the current block
Using the LDL decomposition method as the regression method
   1.4.2.3.

$${pred}_{C} ( i , j ) = {α}_{0} \cdot L 0 + {α}_{1} \cdot L 1 + {α}_{2} \cdot L 2 + {α}_{3} \cdot L 3 + {α}_{4} \cdot L 4 + {a}_{5} \cdot L 5 + {α}_{6} \cdot P ( i , j ) + {α}_{7} \cdot bias$$

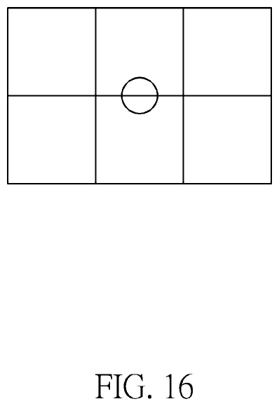

In this expression of the target sample being chroma, sourceTermSet0 includes six taps as L0 to L5 and one tap P as a nonlinear term, sourceTermSet1 is not used, and biasTerm refers to another one tap as midValue. L0 to L5 refer to the corresponding not-downsampling luma reconstructed samples referred by the to-be-predicted chroma (i, j). P is generated by any one or multiple corresponding not-downsampling luma reconstructed samples. For example, (average of the two pre-defined corresponding luma samples+1)>>1) is used and/or P is obtained following the non-linear term in CCCM method, for example, CCCM method in the intra process. The two pre-defined corresponding luma samples refers the two above and bottom nearing to the circle (denoted as the circle in FIG. 16).

The model parameters a0 to a7 are derived by using a regression method and/or not using division operations. Before deriving the parameters, the proposed offsets are used to adjust the input samples.

In one embodiment, when generating the target predictors of the current block and/or generating the template predictors on the reference region of the current block, a long-tap post-filter is applied. The filtering shape can be any pattern proposed in the above invention.

In another embodiment, sourceTermSet1 is also used. For example, one or more additional taps for sourceTermSet1 refer to the initial predicted sample (i, j) for the current block and/or a pattern around (i, j) generated by using the prediction mode for the current block. For inter coding unit containing luma and chroma blocks, the initial predicted sample (i, j) refers to the motion compensated results by using the motion information (motion vectors and/or reference pictures) of the current block. For IBC or intraTMP, the initial predicted sample (i, j) refers to the motion compensated results (specifically, block compensated results) by using the motion information (specifically, the block information as block vectors and/or current picture) of the current block. The additional taps are derived by using the spatial-neighboring reference region of the current block.

In another embodiment, sourceTermSet0 or sourceTermSet1 may include gradient terms in other examples.

### 2. Build a Candidate Set or List Including Cross-Component Models

In one embodiment, when building the merge-like candidate model set or list (modelList), one or more than one of the following candidate model information, for example, inherited candidates, are included.
Spatial model information from spatial neighbour blocks (corresponding to “Spatial MVP from spatial neighbour CUs” for inter)
Temporal model information from collocated blocks (corresponding to “Temporal MVP from collocated CUs” for inter)
History-based model information from a FIFO table (corresponding to “History-based MVP from a FIFO table” for inter)
Pairwise average model information (corresponding to “Pairwise average MVP” for inter)
Default model information (corresponding to “Zero MVs” for inter)

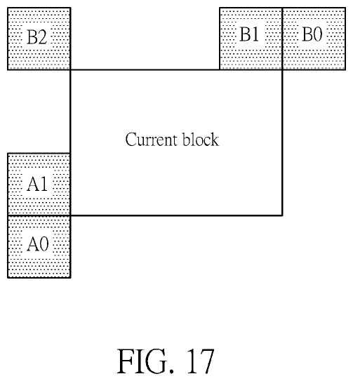

In one sub-embodiment of the candidate type being “Spatial model information from spatial neighbour blocks”, a valid spatial neighboring block(s) can be from one of spatial adjacent and/or non-adjacent neighbors (or any subset of the blocks in a neighboring search region for the current block) which satisfies a pre-defined condition. For example, the pre-defined condition is that the neighbor is coded by a cross-component mode (such as CCLM, MMLM, CCCM, GLM, the mode with mode or model information inherited from a merge-like candidate list, multiple hypotheses (MH) CCLM which combines multiple hypotheses of cross-component prediction to derive the final prediction for a MH CCLM coded block, and/or any cross-component mode with syntax not belonging to tradition intra prediction modes) or combining with cross-component mode (such as chroma fusion (or named LM assisted Angular/Planar Mode), inter CCLM, and/or any traditional mode with syntax not belonging to cross-component modes but using the cross-component information to generate the prediction). When scanning the spatial neighboring blocks, a candidate is added into the list if the candidate is valid. The following show some scanning orders when adding the Spatial model information from spatial neighbour blocks into the list.
For example, as illustrated in FIG. 17, the scanning order follows B1 (above)→A1 (left)→B0 (right-above)→A0 (left-bottom)→B2 (left-above) or any pre-defined order.
For example, the scanning order follows adjacent candidates are prior to (or after) the non-adjacent candidates.

In another sub-embodiment of Temporal model information from collocated blocks, the collocated block is from the block in the reference or collocated picture as inter mode. For example, when the current block is coded by inter prediction mode, the collocated block is referred by the motion information (including the motion vectors and/or the reference picture) of the current block. If the current block is a subblock motion mode (e.g. affine mode), each subblock in the current block has its own collocated temporal model information and/or all or any subset of collocated temporal model information referred by the different subblock motions are added into the list. For another example, the temporal model information can be from the collocated block referred by the motion information of the neighboring blocks for the current block. If the proposed methods are applied to an IBC block or any mode using block vectors, block vector information is used as motion vector where the block vector information is determined by signalling and/or template matching in a pre-defined searching range and/or any implicit or explicit pre-defined rules.

In another sub-embodiment of History-based model information, a history-based table (the FIFO table) is built and stores the model information from the previous coded blocks. The table can be reset as the beginning and/or end of a CTU, CTU row, slice, picture, tile, and/or sequence. One or more than one history-based candidates can be added into the candidate list by the order from the head to tail of the table or from the tail to head of the table.

In another sub-embodiment of Pairwise average model information, the model information of this candidate is derived based on the model information from more than one of the previous candidates in the list. For example, it could average and/or modify the model parameters of more than one candidate as the to-be-applied model parameters. For another example, it could combine more than one prediction as the final prediction, where each of more than one predictions are generated by applying one of models in the candidate list.

In another sub-embodiment, the default model information is added if the list is not full after inserting all pre-defined candidates. Some examples of the default CCLM model information show below.
For example, the default alpha (or named as a, a, or scaling parameters) are {0, 1/8, −1/8, 2/8, −2/8, 3/8, −3/8, . . . }, and the beta (or named as β, b, or offset parameter) is based on the selected default alpha, average neighboring reconstructed luma sample value, and average neighboring reconstructed chroma (Cb/Cr) sample value.

In another sub-embodiment, when selecting one candidate from the list and using the model information from the candidate for the current block or when inheriting the model information from a previous coded block (when putting one candidate into the list), only a subset of the model information is inherited. For example, only the alpha is inherited. The beta is obtained for the current block through the inherited alpha, average neighboring reconstructed luma sample value, and/or average neighboring reconstructed chroma (Cb/Cr) sample value. For example, when inheriting MMLM model information, the scaling parameters and/or the classification threshold are inherited. The offset parameter in each class is derived according to the inherited classification threshold and/or the average neighboring reconstructed luma sample value, and/or average neighboring reconstructed chroma (Cb/Cr) sample value in each class. If no neighboring reconstructed samples are available in a class, the offset parameter is directly inherited from the candidate. For example, when inheriting CCCM model information, all convolution parameters, offsets, and/or the classification threshold are inherited. For example, when inheriting GLM model information, if the GLM candidate is 3-parameter GLM mode, all the gradient pattern indices and model parameters are inherited; otherwise, if the GLM candidate is the 2-parameter GLM mode, the offset parameter is derived by using the inherited scaling parameter, average neighboring reconstructed luma sample value, and/or average neighboring reconstructed chroma (Cb/Cr) sample value. For example, when inheriting chroma fusion model information, the derived MMLM parameters are inherited and used as when inheriting a MMLM candidate for the current block.

In another sub-embodiment, when selecting one candidate from the list and using the model information from the candidate for the current block, all model information is inherited. For example, both the alpha and beta are inherited.

In another embodiment, for the current block being a larger block with block width, height, or area larger than a pre-defined threshold, the current block is split into multiple subblocks. For example, the splitting rule is that a minimum block size is pre-defined and the current block is split until the subblock width or height meets the minimum block size. For another example, the splitting rule follows quad tree (4 subblocks) or binary tree (2 subblocks) splitting. In one sub-embodiment, each subblock will have its own set or list. In another embodiment, an implicit rule is defined to select the model (from the set or list) for each subblocks. For example, the implicit rule is to use the spatial model information for the subblocks near the top boundary or left boundary of the current block and/or use the temporal model information for the subblock (e.g. the subblock at the right-bottom portion of the current block) far away from the top boundary or left boundary of the current block. If the current block is split into 4 subblocks by quadtree, the subblock at the top-left uses the spatial candidate model from B2, the subblock at the right-top uses the spatial candidate model from B1 or B0, the subblock at the left-bottom uses the spatial candidate model from A1 or A0, and/or the subblock at the right-bottom uses the temporal candidate model. Subblocks without any significant luma residual and/or cbf are skipped.

In another embodiment, when building modelList, one or more self-derived cross-component candidates are included. In one sub-embodiment, the self-derived cross-component candidates are added only when the set or list contains not enough inherited candidates or any inherited candidates are found. The self-derived cross-component candidate refers to one or more models and the models are used to generate the cross-component prediction of the current block. For example, the self-derived candidates are described in section “Self-derived cross-component candidates”.

### 3. Signalling of Enabling or Disabling and Selecting One or More Model Information in the List if Enabling

For an inter block as an example, when not applying the proposed inter CCLM (or inter CCCM), the prediction of current block is from original inter prediction.

For an intra block as an example, when not applying the proposed methods (which use the model information to generate one or more hypotheses of prediction for the current chroma component (Cb or Cr) by applying and/or modifying the selected model information to the reconstructed or predicted samples for the corresponding luma component), the prediction of current block is from original intra prediction.

In another embodiment, the choice between applying the proposed methods, for example, inter CCLM, or not applying the proposed methods, for example, inter CCLM, depends on signaling.

In one sub-embodiment, the signalling refers to a coded TU/TB/CU/CB level flag. The flag may or may not depend on context to code. Take the TU/TB flag as an example, the flag is signalled only if the TU/TB's luma Cbf is non-zero and the enabling flag for the inter mode (if the proposed methods are used for the block coded by inter mode) is true. Take the CU/CB flag as an example, the flag is signalled only if the CU/CB's luma Cbf is non-zero and the enabling flag for the inter mode (if the proposed methods are used for the block coded by inter mode) is true. The enabling flag for the inter mode means the CU's predMode is MODE_INTER when the proposed inter CCLM (or inter CCCM) is supported for all inter modes. When the proposed inter CCLM (or inter CCCM) is supported for IBC. The enabling flag for IBC is checked first and the signalling for inter CCLM (or inter CCCM) is coded/decoded in response of the CU's predMode being MODE_IBC.

In another sub-embodiment, a flag is signalled in the bitstream to indicate whether to apply the proposed methods, for example, inter CCLM (or inter CCCM), or not. For example, the flag is context coded. For another example, only one context is used when coding the flag. For another example, multiple contexts are used to code the flag and the selection of the contexts depends on block width, block height, block area, or neighboring mode information.

In another sub-embodiment, when the signaling indicates to apply the proposed methods, for example, inter CCLM (or inter CCCM), additional signaling is used to select one or more than one models from total candidates (e.g. CCLM_LT, CCLM_L, CCLM_T, MMLM_L, MMLM_T, MMLM_L, any self-derived candidates, any inherited candidates, or any subset/extension from the above mentioned modes). For example, if one cross-component mode, for example, LM mode is selected, the cross-component prediction, for example, LM prediction, is generated by the selected one cross-component model, for example, LM. For another example, if more than one cross-component mode, for example, LM modes, are selected the cross-component prediction, for example, LM prediction, is generated by blending hypotheses of predictions from multiple cross-component modes, for example, LM modes. For another example, the additional signaling refers to an index in the bitstream which can be truncated unary coding with and/or without contexts.

In another sub-embodiment, when the signaling indicates to apply the proposed methods, for example, inter CCLM (or inter CCCM), one or more than one models from total candidates (e.g. CCLM_LT, CCLM_L, CCLM_T, MMLM_L, MMLM_T, MMLM_L, any self-derived candidates, any inherited candidates, or any subset/extension from the above mentioned modes) is (are) implicitly selected (or predefined) to be used in the proposed methods, for example, inter CCLM. Here takes inter blocks as an example. The proposed methods are not limited to using for inter blocks and/or can be applied to intra and/or IBC blocks.
For example, CCLM_LT is used to generate LM prediction for inter CCLM. For example, MMLM_LT is used to generate LM prediction for inter CCLM. Similar rules can be applied to inter CCCM with using convolutional models instead.
For another example of inter CCLM, the predefined rule depends on block width, block height, or block area. Similar rules can be applied to inter CCCM with using convolutional models instead.
   Boundary matching setting (used as the predefined rule) can be applied only when the block width, block height, or block area is larger than a threshold. Boundary matching setting (used as the predefined rule) can be applied only when the block width, block height, or block area is smaller than a threshold. When the block width, block height, or block area is smaller than a threshold, the selected LM mode(s) is (are) inferred as any one (more than one) LM mode(s) from total candidate LM modes.
      The selected LM mode is fixed as CCLM_LT.
      The selected LM mode is fixed as MMLM_LT.
For another example, the predefined rule depends on boundary matching setting. (Details of boundary matching setting can be found in the section of boundary-matching setting. The candidate mode used in the section of boundary-matching setting refers to each candidate LM mode for inter CCLM. The prediction from a candidate mode used in the section of boundary-matching setting refers to the prediction generated by each candidate LM mode or refers to the blended prediction from each candidate LM mode and original inter.) Similar rules can be applied to inter CCCM with using convolutional models instead.

In another embodiment, the proposed methods, for example, inter CCLM (or inter CCCM), can be supported only when the size conditions of the current block are satisfied.

In one sub-embodiment, the size condition is that the block width, block height, or block area is larger than a pre-defined threshold. The predefine threshold can a positive integer like 8, 16, 32, 64, 128, 256, . . . .

In another sub-embodiment, the size condition is that the block width, block height, or block area is smaller than a pre-defined threshold. The predefine threshold can a positive integer like 8, 16, 32, 64, 128, 256, 512, 1024, 2048, 4096 . . . .

In another embodiment, when the proposed methods are used for an inter block, the inter mode used in the inter block depends on an enabling flag. For example, if the inter mode is regular merge, the enabling flag is called as regular merge flag. For another example, if the inter mode is CIIP, the enabling flag is called as CIIP flag. For another example, if the inter mode is CIIP PDPC, the enabling flag is called as CIIP PDPC Flag. For another example, the enabling flag indicated as enabled (equal to 1) means the corresponding inter mode is applied to the current block. For another example, the enabling flag indicated as disabled (equal to 0) means the corresponding inter mode is not applied to the current block. For another example, the enabling flag is signalled in the bitstream and/or inferred in some cases. For another example, the signaling of the enabling flag depends on block width, block height, or block area.

In another embodiment, when the proposed methods are used for an inter block, the prediction from inter can be adjusted by the neighboring reconstructed samples and a pre-defined weighting scheme. For example, when the current block is merge, the prediction from merge is blended with the neighboring reconstructed samples. For another example, the proposed scheme is enabled depending on CIIP PDPC flag. (The CIIP PDPC flag may be signalled when the CIIP flag is indicated as enabled.) For another example, the pre-defined weighting scheme follows PDPC weighting.

### (Details can be Found in the Following)

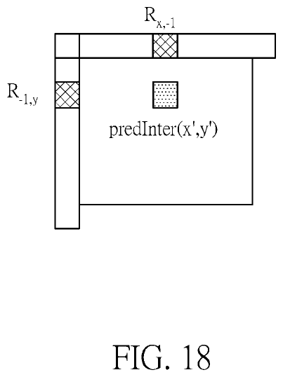

Inter-predictor of regular merge mode is refined using the above R_{x,-1} and left R_{-1,y} reconstructed samples, as illustrated in FIG. 18

Derivation of nScale and wT & wL are the same as in intra planar mode

$$wT = 32 ≫ ( ( y ≪ 2 ) ≫ nScale )$$

$$wL = 32 ≫ ( ( x ≪ 1 ) ≫ nScale )$$

$$nScale = ( floorLog 2 ( width ) + floorLog 2 ( height ) - 2 ) ≫ 2 ;$$

### CIIP PDPC:

If LMCS is enabled, inter-predictor is computed in mapped domain

$$Pred ( x , y ) = ( ( ( ( wT \times {R}_{x , - 1} + wL \times {R}_{- 1 , y} + 32 ) ≫ 6 ) ≪ 6 ) + ( 64 - wT - wL ) \times Fwd ( predInter ( x , y ) ) + 32 ≫ 6$$

Otherwise, inter-predictor is computed in original domain

$$Pred ( x , y ) = ( ( ( ( wT \times {R}_{x , - 1} + wL \times {R}_{- 1 , y} + 32 ) ≫ 6 ) ≪ 6 ) + ( 64 - wT - wL ) \times predInter ( x , y ) + 32 ) ≫ 6$$

When CIIP flag is true, CIIP PDPC flag is further signaled to indicate whether to use CIIP PDPC

In another embodiment, original inter or intra prediction (generated by motion compensation or original intra prediction, for example, non-cross-component intra prediction) is used for luma and the predictions of chroma components are generated by cross-component modes, for example, CCLM and/or any other LM modes.

In one sub-embodiment, the current CU is viewed as an inter CU, intra CU, or a new type of prediction mode (neither intra nor inter).

In another embodiment, (*) The one or more LM mode(s) (or cross-component mode(s)) which will be used to generate the one or more hypotheses of predictions for LM assisted Angular/Planar Mode/inter CCLM/MH CCLM are selected from a pre-defined merging candidate set or list (called modelList). One modelIdx is signalled to select a candidate from the candidate set or list (modelList) and the selected candidate is used for the current block. The modelList contains one or more candidates where each candidate refers to a model (or cross-component mode) information. If only one candidate is in the set or list (the size of the set or list is only 1), the modelIdx is not signalled and/or can be inferred as 0 or a default value.

In one embodiment, when building modelList, one or more predefined candidates are added. The pre-defined candidates can include any subset/extension of the following candidates.
CCLM family: CCLM_LT, CCLM_L, CCLM_T
MMLM family: MMLM_LT, MMLM_L, MMLM_T
CCCM family: CCCM_LT, CCCM_L, CCCM_T

The above proposed methods can be also applied to IBC blocks or the blocks with any IBC sub-modes (e.g. IBC merge or IBC AMVP or any IBC mode under IBC syntax). (“inter” in this invention can be changed to IBC.) That is, for chroma components, the block vector prediction can be combined or replaced with cross-component prediction.

### 4. Use the Model Information to Generate One or More Hypotheses of Predictions for the Current Chroma Component.

In one embodiment, prediction or reconstruction-based model is used to generate one hypothesis of prediction for the current chroma component.

In one embodiment of a prediction based linear model, the derived model parameters are applied to the predicted samples for the first component (Y) to get the predicted samples for the second or third component.

$$P ( i , j ) = a \cdot {pred}_{L}^{′} ( i , j ) + b$$

The predicted samples for the first component are down-sampling with the downsampling filters (which may be fixed at one-predefined filter or selected among some candidate filters). For example, the downsampling filters follow the original LM design. For another example, the downsampling filters will not access neighboring predicted/reconstructed samples. At the boundary of the current block, if the neighboring samples are required to be the input samples of downsampling filters, padded predicted values from the boundary of current block are used instead.

In another sub-embodiment of a reconstruction based linear model, the derived model parameters are applied to the reconstructed samples for the first component (Y) to get the predicted samples for the second or third component.

$$P ( i , j ) = a \cdot {reco}_{L}^{′} ( i , j ) + b$$

The reconstructed samples for the first component are down-sampling with the downsampling filters (which may be fixed at one-predefined filter or selected among some candidate filters). For example, the downsampling filters follow the original LM design. For another example, the downsampling filters will not access neighboring predicted/reconstructed samples. At the boundary of the current block, if the neighboring samples are required to be the input samples of downsampling filters, padded predicted values from the boundary of current block are used instead.

Prediction or reconstruction based convolution model is similar to the proposed methods for the prediction or reconstruction based linear model. The main difference is that the model coefficient pattern follows CCCM (not CCLM) and the luma samples may or may not be down-sampled first. If not applying down-sampling to the luma samples, more taps (model coefficients) may be used to access the non-down-sampled luma samples.

In another embodiment, multiple-hypotheses (MH) of cross-component predictions, for example, predictions from MH CCLM, are blended or multiple models are used to generate a hypothesis of prediction for the current block. Each CCLM method is suitable for different scenarios. For some complex feature, the combined prediction may bring better performance. Therefore, multiple-hypothesis CCLM is proposed to blend the predictions from multiple CCLM methods. The to-be-blended CCLM methods can be from (but are not limited to) the above mentioned CCLM methods and/or (*) and/or any proposed inherited or self-derived candidates. A weighting scheme is used for blending.

In one embodiment, the weights for different cross-component methods, for example, CCLM methods, are pre-defined at encoder and/or decoder.

In another embodiment, the weights vary based on the distance between the sample (or region) positions and the reference sample positions.

In another embodiment, the weights depend on the neighboring coding information.

In another embodiment, a weight index is signaled and/or parsed. The code words can be fixed or vary adaptively. For example, the code words vary with template-based methods.

Similar rules can be applied to CCCM with using convolutional models instead or the MH methods can be applied cross different cross-component methods, for example, CCLM and CCCM. For example, one hypothesis from CCLM and another hypothesis from CCCM.

### 5. Modifications on LM Assisted Angular/Planar Mode

For traditional intra prediction modes (e.g. angular intra prediction modes, DC, and planar), the reference samples are from top and left neighboring reconstructed samples. Therefore, the accuracy of intra prediction decreases for right-bottom samples within the current block. In this section, LM is used to improve the prediction from traditional intra prediction modes.

In one embodiment, the current block's prediction is formed by a weighted sum of one or more hypotheses of predictions from traditional intra prediction mode(s) and one or more hypotheses of predictions from LM mode(s) (or cross-component mode(s)).
In one sub-embodiment, equal weights are applied to both.
In another sub-embodiment, weights vary with neighboring coding information, sample position, block width, height, mode or area.
   For example, when the sample position is far away from the top-left region, the weight for the prediction from traditional intra prediction modes decays. The following shows some examples.
One possible rule related to sample position is described as follows.
   When the sample position is further away from the reference samples, the weight for the prediction from other intra prediction modes decreases.
Another possible rule related to neighbouring coding information is described as follows.
   When more neighbouring blocks (left, above, left-above, right-above, and/or left-bottom) are coded with a particular (e.g. Mode A), the weight for the prediction from Mode A gets higher. For example, Mode A refers to a specific cross-component mode such as CCCM_LT or a specific cross-component family such as CCCM family (including CCCM_LT, CCCM_L, and/or CCCM_T) and/or CCLM family (including CCLM_LT, CCLM_L, and/or CCLM_T) and/or MMLM family (including MMLM_LT, MMLM_L, and/or MMLM_T). A weighting set is pre-defined to include multiple weighting candidates such as {1, 3}, {3, 1}, and/or equal weighting {2, 2} for one prediction from a traditional intra prediction mode and the other prediction from a cross-component mode. When all or most of the neighbouring blocks are coded by Mode A, the weighting candidate with a higher weight for the prediction from a cross-component mode is used. When only partial or one of the neighbouring blocks are coded by Mode A, the weighting candidate with an equal weighting is used. When few or none of the neighbouring blocks are coded by Mode A, the weighting candidate with a smaller weight for the prediction from a cross-component mode is used. For example, the neighbouring blocks include any subset of the coded blocks which are spatially adjacent to the top boundary or left boundary of the current block. In this case, the neighbouring blocks may refer to the top neighbouring block (located on the top of the top-right corner of the current block) and the left neighbouring block (located on the left of the bottom-left corner of the current block). For another example, the neighbouring blocks include any subset of the coded blocks located in a pre-defined range spatially nearing the top boundary or left boundary of the current block. In this case, the neighbouring blocks can be adjacent or non-adjacent to the current block.
Another possible rule related to sample position is described as follows.
   The current block is partitioned into several regions. The sample positions in the same region share the same weighting. If the current region is close to the reference L neighbour, the weight for prediction from other intra prediction modes is higher than the weight for prediction from CCLM. The following shows some possible ways to partition the current block.
      (ratio of width and height close to or exactly 1:1): The distance between the current region and the left and top reference L neighbour is considered.
      (width>n*height, where n can be any positive integer): The distance between the current region and the top reference L neighbour is considered.
      (height>n*width, where n can be any positive integer): The distance between the current region and the left reference L neighbour is considered.

In another sub-embodiment, the to-be-propagated mode for the current block (using chroma fusion or named as LM assisted Angular/Planar Mode, inter CCLM, or MH CCLM) is set/stored as the inherited mode, for example, the inherited mode for the subsequent coding blocks, such as one or more cross-component models, for example, CCLM, MMLM, CCCM, or GLM.

In another sub-embodiment, the candidate types are aligned with the candidate types for the merge mode.

In another sub-embodiment, when building the list, pruning operations are applied to avoiding duplicated candidates in the list.

In another sub-embodiment, the signalling of the modelIdx depends on context coding, block width, block height, block area, and/or explicit syntax such as SPS, PPS, slice, CTU, picture, sequence, and/or tile level signalling.

In another sub-embodiment, the candidate selection (from the set or list) for the current block depends on a pre-defined process. For example, the pre-defined process is a TIMD or DIMD-like method. For example, the pre-defined process depends on the neighboring template of the current block. For example, the pre-defined process depends on the mode information on the neighboring blocks. If most of the pre-defined neighboring blocks use a specific mode, the first candidate (in the list) referring to the specific mode is selected. The signalling of the modelIdx is bypass (not required for signalling).

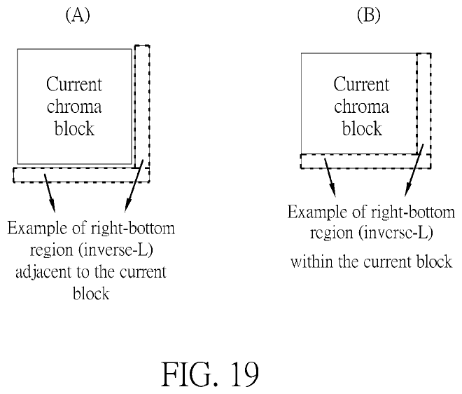

In another embodiment, it is proposed to use LM mode to generate the right-bottom region within or nearing the current block. When doing intra prediction, the reference samples can be based on not only original left and top neighboring reconstructed samples but also proposed right and bottom LM-predicted samples. The following shows an example.
Before doing intra prediction for a chroma block, the collocated luma block is reconstructed.
“The neighboring luma reconstructed samples of the collocated luma block” and “the neighboring chroma reconstructed samples of the current chroma block” are used for deriving LM parameters.
“The reconstructed samples of the collocated luma block” with the derived parameters are used for obtaining the right-bottom LM-predicted samples of the current chroma block. (Right-bottom region of the current chroma block can be any subset of the region in FIG. 19.)
The prediction of the current block is generated bi-directionally by referencing original L neighboring region (original top and left region, obtained using a traditional intra prediction mode) and proposed inverse-L region (obtained using LM).

In one sub-embodiment, the predictors from the original top and left region and the predictors from bottom and left region are combined with weighting.
In one example, equal weights are applied to both.
In one example, weights vary with neighboring coding information, sample position, block width, height, mode, or area.
   E.g., when the sample position is far from the top and left region, the weight for the prediction from the traditional intra prediction mode decays.
In another embodiment, this proposed method can be applied to inverse LM. Then, when doing luma intra prediction, the final prediction is bi-directional. (similar to the above example for a chroma block)
In another embodiment, after doing segmentation to know the curve pattern for luma, the proposed LM assisted Angular/Planar Mode assists chroma with getting the correct curved angle.

### Inverse LM

For the CCLM mode as disclosed earlier, luma reconstructed samples are used to derive the predictors in the chroma block. In this disclosure, inverse LM is proposed to use chroma information to derive the predictors in the luma block. When supporting inverse LM, chroma are encoded/decoded (signalled/parsed) before luma.

In one embodiment, the chroma information refers to the chroma reconstructed samples. When deriving model parameters for inverse LM, reconstructed neighbouring chroma samples are used as X, which are used to predict luma for model derivation, and reconstructed neighbouring luma samples are used as Y, which are used as the target for model derivation. Moreover, the reconstructed samples in the chroma block (collocated to the current luma block) and the derived parameters are used to generate the predictors in the current luma block. An alternative way is that “information” in this embodiment can refer to predicted samples.

In one embodiment, chroma refers to cb and/or cr component(s).

In one sub-embodiment, only one of cb's and cr's information is used.

In another sub-embodiment, the chroma information is from both cb and cr. For example, the neighbouring reconstructed cb and cr samples are weighted and then used as the inputs of deriving model parameters. In another example, the reconstructed cb and cr samples in the chroma block (collocated with the current luma block) are weighted and then used to derive the predictors in the current luma block.

In another embodiment, for the current luma block, the prediction (generated by the proposed inverse LM) can be combined with one or more hypotheses of predictions (generated by one or more other intra prediction modes).

In one sub-embodiment, “other intra prediction modes” can refer to angular intra prediction modes, DC, planar, MIP, ISP, MRL, any other existing intra modes (supported in HEVC/VVC) and/or any other intra prediction modes.

In another sub-embodiment, when combining multiple hypotheses of predictions, weighting for each hypothesis can be fixed or adaptively changed. For example, equal weights are applied to each hypothesis. In another example, weights vary with neighbouring coding information, sample position, block width, height, prediction mode or area. Some examples of neighbouring coding information usage are shown as follows:
One possible rule related to sample position is described as follows.
   When the sample position is further away from the reference samples, the weight for the prediction from other intra prediction modes decreases.
Another possible rule related to neighbouring coding information is described as follows.
   When more neighbouring blocks (left, above, left-above, right-above, and/or left-bottom) are coded with a particular (e.g. Mode A), the weight for the prediction from Mode A gets higher.
Another possible rule related to sample position is described as follows.
   The current block is partitioned into several regions. The sample positions in the same region share the same weighting. If the current region is close to the reference L neighbour, the weight for prediction from other intra prediction modes is higher than the weight for prediction from CCLM. The following shows some possible ways to partition the current block.
      (ratio of width and height close to or exactly 1:1): The distance between the current region and the left and top reference L neighbour is considered.
      (width>n*height, where n can be any positive integer): The distance between the current region and the top reference L neighbour is considered.
      (height>n*width, where n can be any positive integer): The distance between the current region and the left reference L neighbour is considered.

### Boundary-Matching Setting

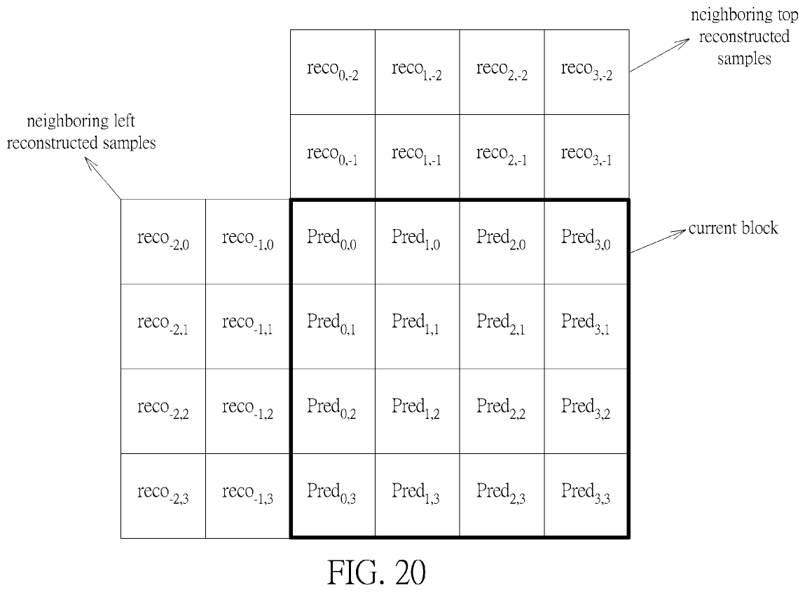

When boundary-matching setting is used, a boundary matching cost for a candidate mode refers to the discontinuity measurement (including top boundary matching and/or left boundary matching) between the current prediction (the predicted samples within the current block), generated from the candidate mode, and the neighboring reconstruction (the reconstructed samples within one or more neighboring blocks), as illustrated in FIG. 20. Top boundary matching means the comparison between the current top predicted samples and the neighboring top reconstructed samples, and left boundary matching means the comparison between the current left predicted samples and the neighboring left reconstructed samples.

In one embodiment, the candidate mode with the smallest boundary matching cost is applied to the current block.

In another embodiment, the boundary matching cost for Cb and Cr can be added to be the boundary matching cost for chroma, so the selected candidate mode for Cb and Cr will be shared. (That is the selected candidate mode for Cb and Cr will be the same.) In another embodiment, the selected candidate modes for Cb and Cr depend on the boundary matching costs for Cb and Cr, respectively, so the selected candidate modes for Cb and Cr can be the same or different.

In another embodiment, a pre-defined subset of the current prediction is used to calculate the boundary matching cost. n line(s) of top boundary within the current block and/or m line(s) of left boundary within the current block are used. (Moreover, n2 line(s) of top neighboring reconstruction and/or m2 line(s) of left neighboring reconstruction are used.)
Here is an example of calculating a boundary matching cost. (n=2, m=2, n2=2, m2=2)

$$cost = {\sum }_{x = 0}^{block width - 1} ( \vert a * {pred}_{x , 0} - b * {pred}_{x , 1} - c * {reco}_{x , - 1} \vert + \vert d * {reco}_{x , - 1} - e * {pred}_{x , 0} - f * {reco}_{x , - 2} \vert ) + {\sum }_{y = 0}^{block height - 1} ( \vert g * {pred}_{0. y} - h * {pred}_{y , 1} - i * {reco}_{- 1 , y} \vert + \vert j * {reco}_{- 1 , y} - k * {pred}_{0 , y} - l * {reco}_{- 2 , y} \vert )$$

where the weights (a, b, c, d, e, f, g, h, i, j, k, l) can any positive integers such as a=2, b=1, c=1, d=2, e=1, f=1, g=2, h=1, i=1, j=2, k=1, l=1.
Here is another example of calculating a boundary matching cost. (n=2, m=2, n2=1, m2=1)

$$cost = {\sum }_{x = 0}^{block width - 1} ( \vert a * {pred}_{x , 0} - b * {pred}_{x , 1} - c * {reco}_{x , - 1} \vert ) + {\sum }_{y = 0}^{block height - 1} ( \vert g * {pred}_{0. y} - h * {pred}_{y , 1} - i * {reco}_{- 1 , y} \vert )$$

where the weights (a, b, c, g, h, i) can any positive integers such as a=2, b=1, c=1, g=2, h=1, i=1.
Here is another example of calculating a boundary matching cost. (n=1, m=1, n2=2, m2=2)

$$cost = {\sum }_{x = 0}^{block width - 1} ( \vert d * {reco}_{x , - 1} - e * {pred}_{x , 0} - f * {reco}_{x , - 2} \vert ) + {\sum }_{y = 0}^{block height - 1} ( \vert j * {reco}_{- 1 , y} - k * {pred}_{0 , y} - l * {reco}_{- 2 , y} \vert )$$

where the weights (d, e, f, j, k, l) can any positive integers such as d=2, e=1, f=1, j=2, k=1, l=1.
Here is another example of calculating a boundary matching cost. (n=1, m=1, n2=1, m2=1)

$$cost = {\sum }_{x = 0}^{block width - 1} \vert a * {pred}_{x , 0} - c * {reco}_{x , - 1} \vert + {\sum }_{y = 0}^{block height - 1} \vert g * {pred}_{0. y} - i * {reco}_{- 1 , y} \vert$$

where the weights (a, c, g, i) can any positive integers such as a=1, c=1, g=1, i=1.
Here is another example of calculating a boundary matching cost. (n=2, m=1, n2=2, m2=1)

$$cost = {\sum }_{x = 0}^{block width - 1} ( \vert a * {pred}_{x , 0} - b * {pred}_{x , 1} - c * {reco}_{x , - 1} \vert + \vert d * {reco}_{x , - 1} - e * {pred}_{x , 0} - f * {reco}_{x , - 2} \vert ) + {\sum }_{y = 0}^{block height - 1} ( \vert g * {pred}_{0. y} - i * {reco}_{- 1 , y} \vert )$$

where the weights (a, b, c, d, e, f, g, i) can any positive integers such as a=2, b=1, c=1, d=2, e=1, f=1, g=1, i=1.
Here is another example of calculating a boundary matching cost. (n=1, m=2, n2=1, m2=2)

$$cost = {\sum }_{x = 0}^{block width - 1} ( \vert a * {pred}_{x , 0} - c * {reco}_{x , - 1} \vert + {\sum }_{y = 0}^{block height - 1} ( \vert g * {pred}_{0. y} - h * {pred}_{y , 1} - i * {reco}_{- 1 , y} \vert + \vert j * {reco}_{- 1 , y} - k * {pred}_{0 , y} - l * {reco}_{- 2 , y} \vert )$$

where the weights (a, c, g, h, i, j, k, l) can any positive integers such as a=1, c=1, g=2, h=1, i=1, j=2, k=1, l=1.

(The following examples for n and m can also be applied to n2 and m2.)

For another example, n can be any positive integer such as 1, 2, 3, 4, etc.

For another example, m can be any positive integer such as 1, 2, 3, 4, etc.

For another example, n and/or m vary with block width, height, or area.
One possible way is that, for a larger block (area>threshold2), m gets larger.
   Threshold2=64, 128, or 256.
   When area>threshold2, m is increased to 2. (Originally, m is 1.)
   When area>threshold2, m is increased to 4. (Originally, m is 1 or 2.)
Another possible way is that, for a taller block (height>threshold2*width), m gets larger and/or n gets smaller.
   Threshold2=1, 2, or 4.
   When height>threshold2*width, m is increased to 2. (Originally, m is 1.)
   When height>threshold2*width, m is increased to 4. (Originally, m is 1 or 2.)
Another possible way is that, for a larger block (area>threshold2), n gets larger.
   Threshold2=64, 128, or 256.
   When area>threshold2, n is increased to 2. (Originally, n is 1.)
   When area>threshold2, n is increased to 4. (Originally, n is 1 or 2.)
Another possible way is that, for a wider block (width>threshold2*height), n gets larger and/or m gets smaller.
   Threshold2=1, 2, or 4.
   When width>threshold2*height, n is increased to 2. (Originally, n is 1.)
   When width>threshold2*height, n is increased to 4. (Originally, n is 1 or 2.)

The proposed methods in this invention can be enabled and/or disabled according to implicit rules (e.g. block width, height, or area) or according to explicit rules (e.g. syntax on block, slice, picture, sps, or pps level).

The term “block” in this invention can refer to TU/TB, CU/CB, PU/PB, or CTU/CTB.

The term “LM” in this invention can be viewed as one kind of CCLM/MMLM modes or any other extension/variation of CCLM (e.g. any cross-component modes or the proposed CCLM extension/variation in this invention). One variation is MMLM which uses thresholds to decide different models for different samples in the current chroma component. Another variation is that for cb (or cr), deriving model parameters from multiple collocated luma blocks. The following show more possible variations. The variations of CCLM here mean that some optional modes can be selected when the block indication refers to using one of cross-component modes (e.g. CCLM_LT, MMLM_LT, CCLM_L, CCLM_T, MMLM_L, MMLM_T, and/or an intra prediction mode, which is not one of traditional DC, planar, and angular modes) for the current block. The following shows an example of being convolutional cross-component mode (CCCM) as an optional mode. When this optional mode is applied to the current block, cross-component information with a model, including non-linear term, is used to generate the chroma prediction. The optional mode may follow the template selection of CCLM, so CCCM family includes CCCM_LT CCCM_L, and/or CCCM_T.

The proposed methods (for CCLM) in this invention can be used for any other cross-component modes.

Any combination of the proposed methods in this invention can be applied.

Any of the foregoing proposed methods can be implemented in encoders and/or decoders. For example, any of the proposed methods can be implemented in an intra/inter coding module of an encoder, a motion compensation module, a merge candidate derivation module of a decoder. Alternatively, any of the proposed methods can be implemented as a circuit coupled to the intra/inter coding module of an encoder and/or motion compensation module, a merge candidate derivation module of the decoder.

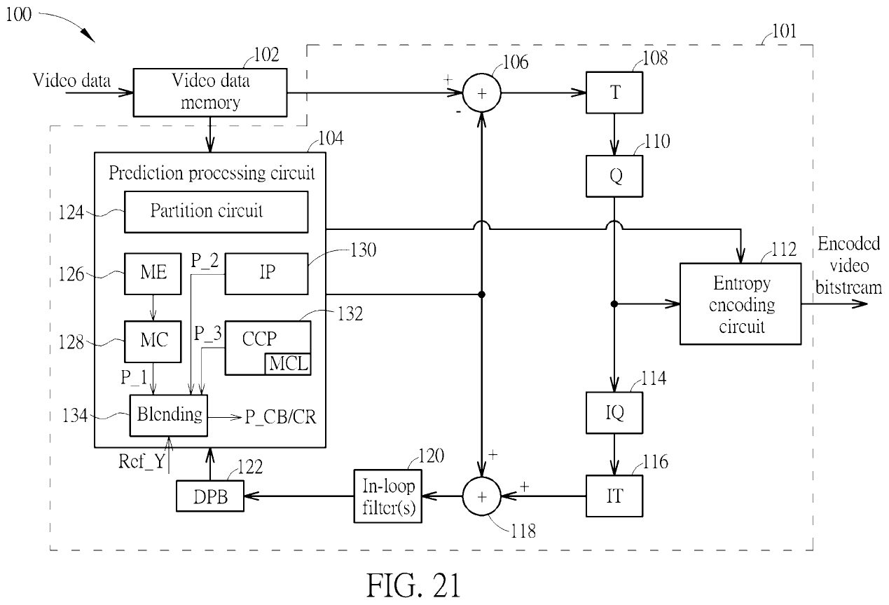

FIG. 21 is a block diagram illustrating a video encoder that supports the proposed prediction mode with chroma prediction improvement according to an embodiment of the present invention. By way of example, but not limitation, the video encoder 100 may be a VVC encoder. The video encoder 100 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence.

As shown in FIG. 21, the video encoder 100 includes an encoding circuit 101 and a video data memory 102. The video data memory 102 is arranged to receive data to be encoded as a current block of pixels of a current picture of a video, wherein the current block may include a luma block and two chroma blocks. The encoding circuit 101 is arranged to perform encoding of the current block by a target prediction mode. The encoding circuit 101 may include a prediction processing circuit 104, a residual generation circuit 106, a transform circuit (labeled by “T”) 108, a quantization circuit (labeled by “Q”) 110, an entropy encoding circuit (e.g., a variable-length code (VLC) encoder) 112, an inverse transform circuit (labeled by “IQ”) 114, an inverse transform circuit (labeled by “IT”) 116, a reconstruction circuit 118, one or more in-loop filters 120, and a decoded picture buffer (DPB) 122. It should be noted that the encoder architecture shown in FIG. 21 is for illustrative purposes only, and is not meant to be a limitation of the present invention. In practice, any video encoder using/supporting the proposed prediction mode with chroma prediction improvement falls within the scope of the present invention.

The prediction processing circuit 104 may include a partition circuit 124, a motion estimation circuit (labeled by “ME”) 126, a motion compensation circuit (labeled by “MC”) 128, an intra prediction circuit (labeled by “IP”) 130, a cross-component prediction circuit (labeled by “CCP”) 132, and a blending circuit (labeled by “Blending”) 134. The motion compensation circuit 128 may be used to generate inter chroma prediction data P_1 of chroma samples in the current block according to any existing inter chroma prediction mode, and output the inter chroma prediction data P_1 to the blending circuit 134. The intra prediction circuit 130 may be used to generate intra chroma prediction data P_2 of chroma samples in the current block according to any existing intra chroma prediction mode such as a DC mode, a planar mode or an angular mode, and output the intra chroma prediction data P_2 to the blending circuit 134. The intra chroma prediction data P_2 is non-cross-component prediction data. The cross-component prediction circuit 132 may be used to generate cross-component prediction data P_3 of chroma samples in the current block according to a cross-component prediction mode, and output the cross-component prediction data P_3 to the blending circuit 134. In addition, the blending circuit 134 may further receive luma reconstructed samples (also called luma reference samples) Ref_Y of the current block.

The prediction processing circuit 104 is shown having the cross-component prediction circuit 132 used to provide the cross-component prediction data P_3 that is distinct from the intra chroma prediction data (non-cross-component prediction data) P_2 provided by the intra prediction circuit 130. However, this is for illustrative purposes only, and is not meant to be a limitation of the present invention. In some embodiments of the present invention, CCP may be a coding tool of intra prediction. That is, CCP belongs to intra prediction for chroma, and the cross-component prediction circuit 132 is one part of the intra prediction circuit 130, and used to provide the cross-component prediction data P_3 that is distinct from the intra chroma prediction data (non-cross-component prediction data) P_2 provided by another part of the intra prediction circuit 130.

The proposed prediction mode with chroma prediction improvement is supported by the prediction processing circuit 104. As the present invention is focused on the proposed prediction mode with chroma prediction improvement and a person skilled in the art should readily understand details of other circuit components included in the video encoder 100, further description of principles of other circuit components included in the video encoder 100 is omitted here for brevity.

The prediction processing circuit 104 is arranged to obtain a first data and a second data when the proposed prediction mode with chroma prediction improvement is selected as the target prediction mode of the current block, wherein the first data may be the cross-component prediction data P_3 (which is derived from cross-component prediction of chroma samples in the current block) or the luma reconstructed samples Ref_Y of the current block, and the second data may be the inter chroma prediction data P_1 (which is derived from inter chroma prediction of chroma samples of the current block) or the intra chroma prediction data P_2 (which is derived from intra chroma prediction of chroma samples of the current block). After the first data and the second data are obtained, the prediction processing circuit 104 (particularly, blending circuit 134 of prediction processing circuit 104) is arranged to determine prediction of chroma samples of the current block (e.g., final chroma predictors P_CB/CR) by jointly considering the first data and the second data. For example, the blending circuit 134 is arranged to perform a fusion function for blending the first data (which may be cross-component prediction data P_3 or luma reconstructed samples Ref_Y) and the second data (which may be inter chroma prediction data P_1 or intra chroma prediction data P_2) according to blending weighting, to generate the final chroma predictors P_CB/CR of chroma samples of the current block. The blending weighting includes weights of the first data and the second data, and each of the final chroma predictors P_CB/CR is a weighted predictor of a corresponding chroma sample.

In some embodiments of the present invention, the blending weighting is derived on a neighboring template of the current block. For example, the neighboring template may include an above reference region of the current block, a left reference region of the current block, an above-left reference region of the current block, or any combination thereof.

In some embodiments of the present invention, the blending weighting used by the blending circuit 134 may be derived on the neighboring template of the current block by using a pre-defined regression method. For example, the pre-defined regression method can be linear minimum mean square error (LMMSE) method as CCLM or can be any unified method with the regression method used for CCLM. For another example, the pre-defined regression method can be the LDL decomposition method as CCCM or can be any unified method with the regression method used for CCCM. For yet another example, the pre-defined regression method can be Gaussian elimination.

In some embodiments of the present invention, the blending weighting used by the blending circuit 134 may be set by pre-defined (fixed) weighting. For example, the pre-defined (fixed) weighting may apply equal weights to the first data and the second data, respectively.

In some embodiments of the present invention, weights of the blending weighting used by the blending circuit 134 may vary with neighboring coding information, sample position, block width of current block, block height of current block, prediction mode of current block, or block area of current block.

The blending weighting derived on the neighboring template of the current block may be regarded as a self-derived model consisting of weights. In some embodiments of the present invention, the self-derived model is designed to blend the first data derived from the luma reconstructed samples Ref_Y and the second data derived from the intra chroma prediction data (e.g., non-cross-component prediction data) P_2.

In some embodiments of the present invention, the cross-component prediction or luma reference samples may be used to adjust the existing intra chroma prediction. The second data used for fusion may be derived from the intra chroma prediction data (e.g., non-cross-component prediction data) P_2 that is generated using any existing intra chroma prediction mode such as a DC mode, a planar mode or an angular mode. The first data used for fusion may be derived from the cross-component prediction data P_3 that is generated using a pre-defined cross-component prediction such as a multiple model cross-component model mode.

The cross-component prediction data P_3 may be selected as the first data to be blended with the second data for chroma prediction improvement. Regarding generation of the cross-component prediction data P_3, the cross-component prediction circuit 132 may construct a merge candidate list MCL for cross-component prediction, and determine a cross-component predictor of a chroma sample of the current block according to a cross-component model candidate selected from the merge candidate list MCL. The difference between the merge candidate list MCL and the inter motion merge candidate list is that the merge candidate list MCL includes inherited cross-component models, while the inter motion merge candidate list includes inherited motion information.

The merge candidate list MCL may include inherited models and/or self-derived models. For example, the merge candidate list MCL may include spatial candidates. Specifically, the cross-component prediction circuit 132 may add a cross-component model located at a spatial neighboring position to the merge candidate list MCL. The spatial neighboring position and a sample position of a chroma sample of the current block are located at the same frame. The spatial neighboring position may be an adjacent position or a non-adjacent position with respect to the boundary of the current block.

For another example, the merge candidate list MCL may include temporal candidates. Specifically, the cross-component prediction circuit 132 may add a cross-component model located at a temporal collocated position to the merge candidate list MCL. The temporal collocated position and a sample position of a chroma sample of the current block are located at the same position in different frames.

For another example, the merge candidate list MCL may include history-based candidates. Specifically, the cross-component prediction circuit 132 may add a cross-component model from a history table to the merge candidate list MCL, wherein the history table may be implemented by a first-in first-out (FIFO) buffer that contains cross-component models of previously coded blocks (i.e., previous chroma blocks that are encoded before the current chroma block).

For another example, the merge candidate list MCL may include candidates derived from previous candidates in the same merge candidate list MCL. Specifically, the cross-component prediction circuit 132 may add a model derived based on model information from more than one previous candidate in the merge candidate list MCL to the merge candidate list MCL.

For another example, the merge candidate list MCL may include default candidates. Specifically, the cross-component prediction circuit 132 may add a default cross-component model (i.e., pre-defined cross-component model) to the merge candidate list MCL.

For another example, the merge candidate list MCL may include self-derived candidates. Specifically, the cross-component prediction circuit 132 may add a self-derived model to the merge candidate list MCL, wherein the self-derived model may be derived using regression based on the template of the current block.

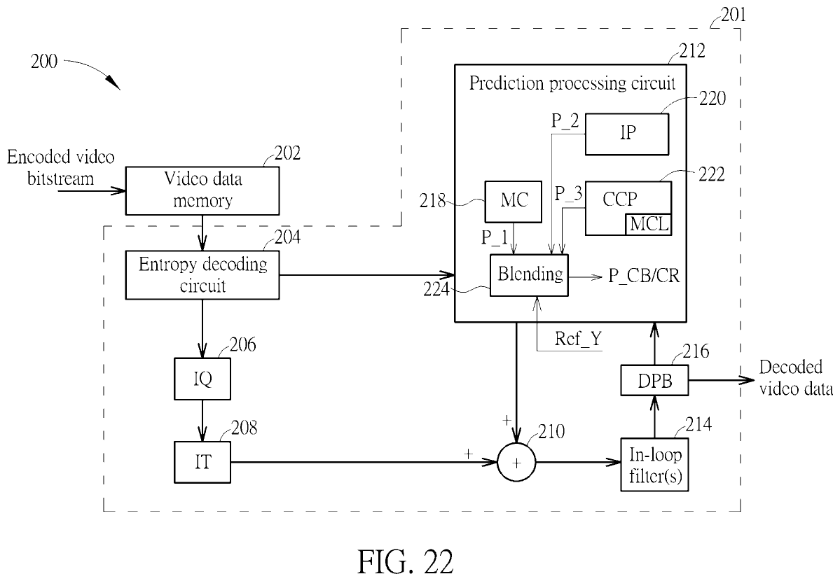

FIG. 22 is a block diagram illustrating a video decoder that supports the proposed prediction mode with chroma prediction improvement according to an embodiment of the present invention. By way of example, but not limitation, the video decoder 200 may be a VVC decoder. The video decoder 200 includes a decoding circuit 201 and a video data memory 202. The video data memory 202 is arranged to receive data to be decoded as a current block of pixels of a current picture of a video, wherein the current block includes a luma block and two chroma blocks. The decoding circuit 201 is arranged to perform decoding of the current block by a target prediction mode. The decoding circuit 201 may include an entropy decoding circuit (e.g., a VLC decoder) 204, an inverse quantization circuit (labeled by “IQ”) 206, an inverse transform circuit (labeled by “IT”) 208, a reconstruction circuit 210, a prediction processing circuit 212, one or more in-loop filters 214, and a decoded picture buffer (DPB) 216. It should be noted that the decoder architecture shown in FIG. 22 is for illustrative purposes only, and is not meant to be a limitation of the present invention. In practice, any video decoder using/supporting the proposed prediction mode with chroma prediction improvement falls within the scope of the present invention.

The prediction processing circuit 212 may include a motion compensation circuit (labeled by “MC”) 218, an intra prediction circuit (labeled by “IP”) 220, a cross-component prediction circuit (labeled by “CCP”) 222, and a blending circuit (labeled by “Blending”) 224. The motion compensation circuit 218 may be used to generate inter chroma prediction data P_1 of chroma samples in the current block according to any existing inter chroma prediction mode, and output the inter chroma prediction data P_1 to the blending circuit 224. The intra prediction circuit 220 may be used to generate intra chroma prediction data P_2 of chroma samples in the current block according to any existing intra chroma prediction mode such as a DC mode, a planar mode or an angular mode, and output the intra chroma prediction data P_2 to the blending circuit 224. The intra chroma prediction data P_2 is non-cross-component prediction data. The cross-component prediction circuit 222 may be used to generate cross-component prediction data P_3 of chroma samples in the current block according to a cross-component prediction mode, and output the cross-component prediction data P_3 to the blending circuit 224. In addition, the blending circuit 224 may further receive luma reconstructed samples (luma reference samples) Ref_Y of the current block.

The prediction processing circuit 212 is shown having the cross-component prediction circuit 222 used to provide the cross-component prediction data P_3 that is distinct from the intra chroma prediction data (non-cross-component prediction data) P_2 provided by the intra prediction circuit 220. However, this is for illustrative purposes only, and is not meant to be a limitation of the present invention. In some embodiments of the present invention, CCP may be a coding tool of intra prediction. That is, CCP belongs to intra prediction for chroma, and the cross-component prediction circuit 222 is one part of the intra prediction circuit 220, and used to provide the cross-component prediction data P_3 that is distinct from the intra chroma prediction data (non-cross-component prediction data) P_2 provided by another part of the intra prediction circuit 220.

The proposed prediction mode with chroma prediction improvement is supported by the prediction processing circuit 212. As the present invention is focused on the proposed prediction mode with chroma prediction improvement and a person skilled in the art should readily understand details of other circuit components included in the video decoder 200, further description of principles of other circuit components included in the video decoder 200 is omitted here for brevity.

The prediction processing circuit 212 is arranged to obtain a first data and a second data when the proposed prediction mode with chroma prediction improvement is selected as the target prediction mode of the current block, wherein the first data may be the cross-component prediction data P_3 (which is derived from cross-component prediction of chroma samples in the current block) or the luma reconstructed samples Ref_Y of the current block, and the second data may be the inter chroma prediction data P_1 (which is derived from inter chroma prediction of chroma samples of the current block) or the intra chroma prediction data P_2 (which is derived from intra chroma prediction of chroma samples of the current block). After the first data and the second data are obtained, the prediction processing circuit 212 (particularly, blending circuit 224 of prediction processing circuit 212) is arranged to determine prediction of chroma samples of the current block (e.g., final chroma predictors P_CB/CR) by jointly considering the first data and the second data. For example, the blending circuit 224 is arranged to perform a fusion function for blending the first data (which may be cross-component prediction data P_3 or luma reconstructed samples Ref_Y) and the second data (which may be inter chroma prediction data P_1 or intra chroma prediction data P_2) according to blending weighting, to generate the final chroma predictors P_CB/CR of chroma samples of the current block. The blending weighting includes weights of the first data and the second data, and each of the final chroma predictors P_CB/CR is a weighted predictor of a corresponding chroma sample.

In some embodiments of the present invention, the blending weighting is derived on a neighboring template of the current block. For example, the neighboring template may include an above reference region of the current block, a left reference region of the current block, an above-left reference region of the current block, or any combination thereof.

In some embodiments of the present invention, the blending weighting used by the blending circuit 224 may be derived on the neighboring template of the current block by using a pre-defined regression method. For example, the pre-defined regression method can be the LMMSE method as CCLM or can be any unified method with the regression method used for CCLM. For another example, the pre-defined regression method can be the LDL decomposition method as CCCM or can be any unified method with the regression method used for CCCM. For yet another example, the pre-defined regression method can be Gaussian elimination.

In some embodiments of the present invention, the blending weighting used by the blending circuit 224 may be set by pre-defined (fixed) weighting. For example, the pre-defined (fixed) weighting may apply equal weights to the first data and the second data, respectively.

In some embodiments of the present invention, weights of the blending weighting used by the blending circuit 224 may vary with neighboring coding information, sample position, block width of current block, block height of current block, prediction mode of current block, or block area of current block.

The blending weighting derived on the neighboring template of the current block may be regarded as a self-derived model consisting of weights. In some embodiments of the present invention, the self-derived model is designed to blend the first data derived from the luma reconstructed samples Ref_Y and the second data derived from the intra chroma prediction data (e.g., non-cross-component prediction data) P_2.

In some embodiments of the present invention, the cross-component prediction or luma reference samples may be used to adjust the existing intra chroma prediction. The second data used for fusion may be derived from the intra chroma prediction data (e.g., non-cross-component prediction data) P_2 that is generated using any existing intra chroma prediction mode such as a DC mode, a planar mode or an angular mode. The first data used for fusion may be derived from the cross-component prediction data P_3 that is generated using a pre-defined cross-component prediction such as a multiple model cross-component model mode.

The cross-component prediction data P_3 may be selected as the first data to be blended with the second data for chroma prediction improvement. Regarding generation of the cross-component prediction data P_3, the cross-component prediction circuit 222 may construct a merge candidate list MCL for cross-component prediction, and determine a cross-component predictor of a chroma sample of the current block according to a cross-component model candidate selected from the merge candidate list MCL. The difference between the merge candidate list MCL and the inter motion merge candidate list is that the merge candidate list MCL includes inherited cross-component models, while the inter motion merge candidate list includes inherited motion information.

The merge candidate list MCL may include inherited models and/or self-derived models. For example, the merge candidate list MCL may include spatial candidates. Specifically, the cross-component prediction circuit 222 may add a cross-component model located at a spatial neighboring position to the merge candidate list MCL. The spatial neighboring position and a sample position of a chroma sample of the current block are located at the same frame. The spatial neighboring position may be an adjacent position or a non-adjacent position with respect to the boundary of the current block.

For another example, the merge candidate list MCL may include temporal candidates. Specifically, the cross-component prediction circuit 222 may add a cross-component model located at a temporal collocated position to the merge candidate list MCL. The temporal collocated position and a sample position of a chroma sample of the current block are located at the same position in different frames.

For another example, the merge candidate list MCL may include history-based candidates. Specifically, the cross-component prediction circuit 222 may add a cross-component model from a history table to the merge candidate list MCL, wherein the history table may be implemented by a FIFO buffer that contains cross-component models of previously coded blocks (i.e., previous chroma blocks that are encoded before the current chroma block).

For another example, the merge candidate list MCL may include candidates derived from previous candidates in the same merge candidate list MCL. Specifically, the cross-component prediction circuit 222 may add a model derived based on model information from more than one previous candidate in the merge candidate list MCL to the merge candidate list MCL.

For another example, the merge candidate list MCL may include default candidates. Specifically, the cross-component prediction circuit 222 may add a default cross-component model (i.e., pre-defined cross-component model) to the merge candidate list MCL.

For another example, the merge candidate list MCL may include self-derived candidates. Specifically, the cross-component prediction circuit 222 may add a self-derived model to the merge candidate list MCL, wherein the self-derived model may be derived using regression based on the template of the current block.

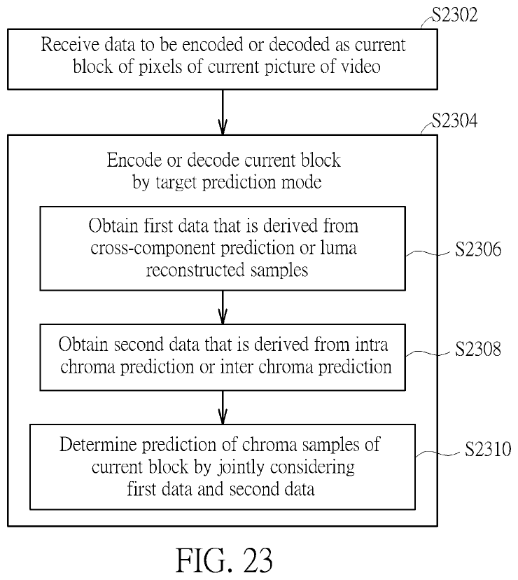

FIG. 23 is a flowchart illustrating a video coding method according to an embodiment of the present invention. The video coding method may be employed by the video encoder 100 shown in FIG. 21 for encoding of video data or the video decoder 200 shown in FIG. 22 for decoding of encoded video bitstream. Provided that the result is substantially the same, the steps are not required to be executed in the exact order shown in FIG. 23. At step S2302, data to be encoded or decoded is received as a current block of pixels of a current picture of a video, wherein the current block includes a luma block and two chroma blocks. At step S2304, encoding or decoding of the current block is performed by the proposed prediction mode with chroma prediction improvement that is selected as a target prediction mode. The step S2304 includes sub-steps S2306, S2308, and S2310. At sub-step S2306, a first data is obtained, wherein the first data is derived from cross-component prediction of chroma samples of the current block or luma reconstructed samples of the current block. At step S2308, a second data is obtained, wherein the second data is derived from intra chroma prediction of the chroma samples of the current block or inter chroma prediction of the chroma samples of the current block. At step S2310, prediction of the chroma samples of the current block is determined by jointly considering (e.g., blending) the first data and the second data. As a person skilled in the art can readily understand details of the video coding method after reading above paragraphs with reference to the accompanying drawings, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for video coding, comprising:
receiving data to be encoded or decoded as a current block of pixels of a current picture of a video, wherein the current block comprises a luma block and at least one chroma block; and
encoding or decoding the current block by a target prediction mode, comprising:
obtaining a first data, wherein the first data is derived from cross-component prediction of chroma samples of the current block or luma reconstructed samples of the current block;
obtaining a second data, wherein the second data is derived from intra chroma prediction of the chroma samples of the current block or inter chroma prediction of the chroma samples of the current block; and
determining prediction of the chroma samples of the current block by jointly considering the first data and the second data.

2. The method of claim 1, wherein determining the prediction of the chroma samples of the current block by jointly considering the first data and the second data comprises:
generating the prediction of the chroma samples of the current block by blending the first data and the second data according to blending weighting.

3. The method of claim 2, wherein the blending weighting is derived on a neighboring template of the current block.

4. The method of claim 3, wherein the neighboring template comprises an above reference region, a left reference region, an above-left reference region, or any combination thereof.

5. The method of claim 3, wherein the blending weighting is derived on the neighboring template by using a regression method.

6. The method of claim 2, wherein the blending weighting is set by pre-defined weighting.

7. The method of claim 6, wherein the pre-defined weighting applies equal weights to the first data and the second data, respectively.

8. The method of claim 2, wherein weights of the blending weighting vary with neighboring coding information, sample position, block width, block height, prediction mode, or block area.

9. The method of claim 1, wherein the first data is derived from the luma reconstructed samples of the current block, and the second data is derived from the intra chroma prediction of the chroma samples of the current block.

10. The method of claim 1, wherein the second data is derived from the intra chroma prediction using a DC mode, a planar mode, or an angular mode.

11. The method of claim 1, wherein the first data is derived from the cross-component prediction using a multiple model cross-component model mode.

12. The method of claim 1, wherein the first data comprises cross-component predictors of the chroma samples, and obtaining the first data comprises:
constructing a merge candidate list for the cross-component prediction; and
determining a cross-component predictor of a chroma sample according to a cross-component model candidate selected from the merge candidate list.

13. The method of claim 12, wherein constructing the merge candidate list for the cross-component prediction comprises:
adding a cross-component model located at a spatial neighboring position to the merge candidate list.

14. The method of claim 12, wherein constructing the merge candidate list for cross-component prediction comprises:
adding a cross-component model located at a temporal collocated position to the merge candidate list.

15. The method of claim 12, wherein constructing the merge candidate list for the cross-component prediction comprises:
adding a cross-component model from a history table to the merge candidate list, wherein the history table contains cross-component models of previously coded chroma blocks.

16. The method of claim 12, wherein constructing the merge candidate list for the cross-component prediction comprises:
adding a model derived based on model information from more than one previous candidate in the merge candidate list to the merge candidate list.

17. The method of claim 12, wherein constructing the merge candidate list for the cross-component prediction comprises:
adding a default cross-component model to the merge candidate list.

18. The method of claim 12, wherein constructing the merge candidate list for the cross-component prediction comprises:
adding a self-derived model to the merge candidate list.

19. A video encoder, comprising:
a video data memory, arranged to receive data to be encoded as a current block of pixels of a current picture of a video, wherein the current block comprises a luma block and at least one chroma block; and
an encoding circuit, arranged to perform encoding of the current block by a target prediction mode, wherein the encoding circuit comprises:
a prediction processing circuit, arranged to obtain a first data, a second data, and determine prediction of chroma samples of the current block by jointly considering the first data and the second data;
wherein the first data is derived from cross-component prediction of the chroma samples of the current block or luma reconstructed samples of the current block; and
the second data is derived from intra chroma prediction of the chroma samples of the current block or inter chroma prediction of the chroma samples of the current block.

20. A video decoder, comprising:
a video data memory, arranged to receive data to be decoded as a current block of pixels of a current picture of a video, wherein the current block comprises a luma block and at least one chroma block; and
a decoding circuit, arranged to perform decoding of the current block by a target prediction mode, wherein the decoding circuit comprises:
a prediction processing circuit, arranged to obtain a first data, a second data, and determine prediction of chroma samples of the current block by jointly considering the first data and the second data;
wherein the first data is derived from cross-component prediction of the chroma samples of the current block or luma reconstructed samples of the current block; and
the second data is derived from intra chroma prediction of the chroma samples of the current block or inter chroma prediction of the chroma samples of the current block.
